(19) United States
(12) Patent Application Publication
(10) Pub. No.: US 2010/0203318 A1
(43) Pub. Date: Aug. 12, 2010

(54) Use of Aluminum Phosphate, Polyphosphate and Metaphosphate Particles in Paper Coating Applications

(75) Inventors: Fernando Galembeck, Campinas (BR); Charles P. Klass, Redington Beach, FL (US)

Correspondence Address: CONNOLLY BOVE LODGE & HUTZ LLP, P.O. BOX 2207, WILMINGTON, DE, 19899, US

(73) Assignees: BUNGE FERTILIZANTES S.A., Sao Paulo (BR); UNIVERSIDADE ESTADUAL DE CAMPINAS, Campinas (BR)

(21) Appl. No.: 12/703,529

(22) Filed: Feb. 10, 2010

Related U.S. Application Data
(60) Provisional application No. 61/151,427, filed on Feb. 10, 2009.

(51) Int. Cl. B32B 3/26; B32B 29/00; B32B 5/16; B05D 3/12

(52) U.S. Cl. 428/314.4; 428/537.5; 428/537.7; 428/328; 428/323; 428/452; 427/361

(57) ABSTRACT

Provided herein are coating compositions for paper comprising aluminum phosphate, aluminum metaphosphate, aluminum orthophosphate and/or aluminum polyphosphate pigments. Methods of making and using the compositions are described.

### CROSS-REFERENCE TO RELATED APPLICATIONS

This patent application claims priority from U.S. Provisional Patent Application Ser. No. 61/151,427 filed on Feb. 10, 2009, and which is incorporated herein by reference in its entirety.

### FIELD OF THE INVENTION

Provided herein are coated papers, including high bulk coated paper, comprising a coating composition on at least one side of a base paper, wherein the coating composition comprises aluminum phosphate, aluminum metaphosphate, aluminum orthophosphate and/or aluminum polyphosphate particles. Methods of making and using the coated paper and the coating compositions are also described.

### BACKGROUND OF INVENTION

Coated paper is used for a large range of products including packaging, board art paper, brochures, magazines, catalogues and leaflets. Such coated paper is required to give a range of properties, including brightness, opacity and sheet gloss, as well as printing performance. Examples of coated papers and coating compositions are described in U.S. Pat. Nos. 7,425,246; 7,407,700; 7,160,419; 7,435,483 and 7,201,826, all of which are incorporated by reference in their entirety.

Coating compositions are generally prepared by forming a fluid aqueous suspension of particulate pigment material together with a binder and other optional ingredients. The coating may conveniently be applied by various coating apparatus used for preparing coated paper. The pigments for use in the coating compositions include titanium dioxide, zeolite and others. However, titanium dioxide is known to be an expensive pigment to manufacture.

There is a continuing need for coated papers with improved properties and cost-effective coating compositions.

### SUMMARY OF THE INVENTION

Provided herein are coated papers comprising a coating composition on at lease one side of a base paper, wherein the coating composition comprises aluminum phosphate, aluminum metaphosphate, aluminum orthophosphate and/or aluminum polyphosphate particles. In certain embodiments, the aluminum phosphate compositions can be used for coating a paper that produces a coated paper with improved characteristics over existing uncoated and coated papers made with other pigments.

In certain embodiments, provided herein is a bulkier, coated paper. In one aspect, provided is a method for making a high bulk, coated paper with the coating forming a lower portion of the total caliper and the paper base forming a higher portion of the total caliper than conventionally made coated paper of the same weight. The process includes the steps of using furnish with a high percentage, say over 50%, and preferably in a range of 55 to 75%, with a target of 60 to 65%, of mechanical pulp, or other similar pulps known in the art, applying that furnish to two or twin wire paper machines, with, for example, a gap former, coating the paper with a coating containing an aluminum phosphate pigment, in one embodiment, in a concentration of 4 or more parts, or 7 or more parts per 100 parts of coating pigment, and calendering the coated paper at a loading less than conventional supercalender loading. In one embodiment, provided herein is a lightweight grade of coated paper such as ultra lightweight coated paper.

In certain embodiments, the coating compositions further include a solvent one or more additives and optionally one or more additional pigments, such as calcium carbonate, including ground calcium carbonate (GCC), precipitated calcium carbonate (PCC), calcined kaolin, hydrous kaolin, delaminated clay, kaolin clay, talc, mica, dolomite, silica, silicates, zeolite, gypsum, satin white, titania, titanium dioxide, calcium sulfate, blanc fixe or barium sulfate, aluminum trihydrate, plastic pigment, and combinations thereof. Suitable additives, for example, can be selected from binders, lubricants, dispersants, eveners, defoamers, wetting agents, optical brighteners, biocides, cross-linkers, water retention aids, viscosity modifiers or thickeners, and combinations thereof. In certain embodiments, the solvent is water.

Generally, the amount of aluminum phosphate, aluminum metaphosphate, aluminum orthophosphate and/or aluminum polyphosphate pigment present in the coating compositions described herein may vary greatly depending upon the desired properties in the final coated paper product. In certain embodiments, the aluminum phosphate, aluminum metaphosphate, aluminum orthophosphate and/or aluminum polyphosphate pigment provided herein is used in the composition in an amount of greater than about 1%, 3%, 5%, 7%, 10%, 12%, 15%, 20%, 25%, 30%, 40% or 50% total weight of solids in the coating composition. In certain embodiments, the coating compositions described herein are aqueous compositions.

The coated paper provided herein is suitable for a variety of printing applications including Giclee printing color copying, xerography, screen printing, gravure, dye-sublimation, flexography, inkjet printing, photography, offset printing, including web offset printing, electrophotographic printing, image recording paper for the thermal transfer recording, ink jet recording, and other applications.

In one aspect, provided herein are ink jet papers and digital printing papers comprising the aluminum phosphate compositions.

In another aspect, provided herein is a coated linerboard for direct post print flexography to prevent smudging and to improve image fidelity comprising the aluminum phosphate compositions. In certain embodiments, aluminum phosphate compositions are used in this application in combination with compositions comprising other pigments known in the art.

In another aspect, provided herein is an ultra lightweight coated publication paper.

It is yet another aspect, provided herein is gravure printing paper comprising the aluminum phosphate compositions.

The coated paper provided herein has improved properties, including improved gloss, smoothness, opacity and/or brightness. In certain embodiments, the coated paper provided herein has a coating gloss equal to or greater than about 20% at 75° measured by TAPPI test method T480 om-92. In certain embodiments, the coated paper provided herein has a smoothness of less than 5.0, 4.0, 3.0, 2.0 or 1.0 as measured using TAPPI test method for Parker Print Surface: T555 om-99. In certain embodiments, the coated paper has an opacity of greater than 80% as measured using TAPPI test method T425 om-91. In certain embodiments, the coated paper has brightness greater than about 70%, 73%, 75%, 77%, 80%, 85% or 90% GE brightness as measured using TAPPI test method T452 om 92.

In one aspect, the aluminum phosphate compositions used in the coated paper provided herein have improved rheology compared to silica and/or other specialty pigments. In certain embodiments, the aluminum phosphate compositions improve coater runnability and/or improve energy consumption in drying. In other embodiments, the aluminum phosphate compositions are in form of water slurries with a higher percentage of solids and good shear thinning rheology compared to existing compositions. Thus, the aluminum phosphate compositions provided herein result in faster on-machine drying rates because of higher percent solid coatings than existing compositions which results in lower drying costs and reduced print smear.

In certain embodiments, the aluminum phosphate compositions have enhanced on-machine coating run ability and therefore enhanced production rates over existing compositions. In other embodiments, the aluminum phosphate compositions have low Einlehner abrasion which results in reduced wear to process equipment and no metallic marks are left on the paper by the gripper bars.

In one embodiment, the aluminum phosphate compositions herein comprise higher composition solids compared to existing compositions. In another embodiment, the aluminum phosphate compositions provided herein have a low bulk density.

In another embodiment, the aluminum phosphate compositions provided herein coat paper with essentially no dusting, have improved optical/reflective densities of four-color cyan, magenta, yellow, black (CMYK) ink jet print, have a narrow particle size distribution with few fines and/or have improved first pass retention in paper machine trials compared to existing compositions.

In yet another embodiment, the aluminum phosphate compositions provided herein make lighter coat weights possible because of internal void volume.

In certain embodiments, the aluminum phosphate compositions provided herein have improved ink jet print density, improved ink receptivity in printing papers and/or improved opacity.

In one embodiment, the aluminum phosphate compositions provided herein have less soak-in and reduced roughening of the base sheet during application which results in a smoother coated sheet.

In another embodiment, the aluminum phosphate compositions provided herein allow higher operating speeds and higher production rates. In yet another embodiment, the aluminum phosphate compositions provided herein have the capability to coat on high speed paper machines rather than only on low speed off machine coating lines which reduces waste and costs.

In one embodiment, the aluminum phosphate compositions provided herein can act as fillers in newsprint to prevent print-through, and as fillers in specialty technical papers such as anti-tarnish, gas filtration, filter, and absorbent papers.

In another embodiment, the aluminum phosphate compositions provided herein are used as microparticulate retention aids, deinking aids in combination flotation-washing systems, or coefficient of friction (COF) control aids in recycled linerboard.

### BRIEF DESCRIPTION OF FIGURES

FIG. 1 provides a comparison of low shear viscosity at 100 RPM for coating compositions comprising aluminum phosphate pigments and the titanium dioxide pigments.

FIG. 2 provides a comparison of high shear viscosity at 100 RPM for coating compositions comprising aluminum phosphate pigments and the titanium dioxide pigments.

FIG. 3 provides low shear viscosity at 100 RPM for coating formulations obtained by gradually replacing TiO₂ with aluminum phosphate pigment.

FIG. 4 provides high shear viscosity at 100 RPM for coating formulations obtained by gradually replacing TiO₂ with aluminum phosphate pigment.

FIG. 5 provides a comparison of water retention property for coating compositions comprising aluminum phosphate pigments and the titanium dioxide pigments.

FIG. 6 provides an impact on water retention of the coating compositions by replacing TiO₂ with aluminum phosphate.

FIG. 7 provides a comparison of opacity of paper coated with compositions comprising aluminum phosphate pigments and the titanium dioxide pigments before calendaring.

FIG. 8 provides a comparison of opacity of paper coated with compositions comprising aluminum phosphate pigments and the titanium dioxide pigments after calendaring.

FIG. 9 provides an impact of replacing TiO₂ with aluminum phosphate pigments on opacity of coated paper.

FIG. 10 provides a comparison of brightness of paper coated with compositions comprising aluminum phosphate pigments and the titanium dioxide pigments before and after calendaring.

FIG. 11 provides an impact of replacing TiO₂ with aluminum phosphate pigments on brightness of coated paper.

FIG. 12 provides a comparison of gloss of paper coated with compositions comprising aluminum phosphate pigments and the titanium dioxide pigments.

FIG. 13 provides an impact of replacing TiO₂ with aluminum phosphate pigments on gloss of coated paper.

FIG. 14 provides a comparison of surface strength of paper coated with compositions comprising aluminum phosphate pigments and the titanium dioxide pigments.

FIG. 15 provides an impact of replacing TiO₂ with aluminum phosphate pigments on surface strength of coated paper.

FIG. 16 provides a comparison of surface coverage for compositions comprising aluminum phosphate pigments and the titanium dioxide pigments.

FIG. 17 shows a plot of gloss versus coating conditions.

FIG. 18 shows a plot of smoothness versus coating conditions.

FIG. 19 shows a plot of brightness versus coating conditions.

FIG. 20 shows a plot of CD (cross direction) gloss versus coating conditions.

FIG. 21 shows a plot of MD (Machine direction) gloss versus coating conditions.

FIG. 22 shows a plot of calendered brightness versus coating conditions.

FIG. 23 shows a plot of calendered smoothness versus coating conditions.

FIG. 24 shows a plot of calendered opacity versus coating conditions.

FIG. 25 depicts a coating preparation schematic for control coating (Formulation #1)

FIG. 26 depicts a coating preparation schematic for 5 part substitution coating (Formulation #2).

FIG. 27 depicts a coating preparation schematic for 10 part substitution coating (Formulation #3).

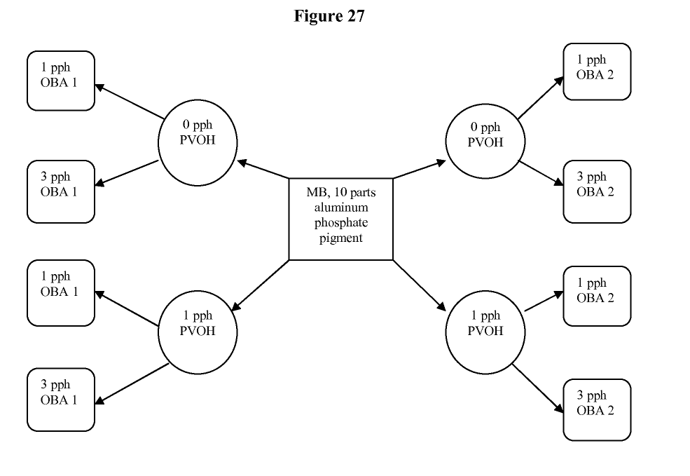

FIG. 28 shows a plot of brightness against the amount of aluminum phosphate pigment, without the addition of PVOH.

FIG. 29 shows a plot of brightness against the amount of aluminum phosphate pigment, with the addition of PVOH.

FIG. 30 shows a plot of fluorescence number against the amount of aluminum phosphate pigment, without the addition of PVOH.

FIG. 31 shows a plot of fluorescence number against the amount of aluminum phosphate pigment, with the addition of PVOH.

In the figures and Examples 1-3, the aluminum phosphate pigment is also referred as Pigment X or PX.

### DESCRIPTION OF EMBODIMENTS OF THE INVENTION

In the following description, all numbers disclosed herein are approximate values, regardless whether the word “about” or “approximate” is used in connection therewith. They may vary by 1 percent, 2 percent, 5 percent, or, sometimes, 10 to 20 percent. Whenever a numerical range with a lower limit, R^{L} and an upper limit, R^{U}, is disclosed, any number falling within the range is specifically disclosed. In particular, the following numbers within the range are specifically disclosed: R═R^{L}+k*(R^{U}—R^{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed.

Provided herein is a coated paper comprising a coating composition on at least one side of a base paper, wherein the coating composition comprises aluminum phosphate, aluminum metaphosphate, aluminum orthophosphate, aluminum polyphosphate particles or combinations thereof. In certain embodiments, the coating compositions further include a solvent, an additive and optionally one or more additional pigments.

The terms “aluminum phosphate” and “aluminum phosphate composition,” as used herein, are meant to include aluminum phosphate as well as aluminum polyphosphate, aluminum orthophosphate, aluminum metaphosphate, and mixtures thereof.

The term “void” referred to herein is generally synonymous with the term “hollow particle,” and is also described herein as a “closed void.” The void (or closed void or hollow particle) is part of a core and shell structure of the aluminum phosphate mixture. The voids may be observed and/or characterized using either transmission or scanning electron microscopes (“TEMs” or “SEMs”). The use of TEMs or SEMs are well known to those of skill in the art. Generally, optical microscopy is limited, by the wavelength of light, to resolutions in the range of a hundred, and usually hundreds, of nanometers. TEMs and SEMs do not have this limitation and are able to attain a considerably higher resolution, in the range of a few nanometers. An optical microscope uses optical lenses to focus light waves by bending them, while an electron microscope uses electromagnetic lenses to focus beams of electrons by bending them. Beams of electrons provide great advantages over beams of light both in control of magnification levels and in the clarity of the image that can be produced. Scanning electron microscopes complement transmission electron microscopes in that they provide a tool to obtain the three dimensional image of the surface of a sample.

Amorphous (i.e., non-crystalline) solids exhibit differences from their crystalline counterparts with a similar composition, and such differences may yield beneficial properties. For example, such differences may include one or more of the following: (i) the non-crystalline solids do not diffract x-rays at sharply defined angles but may produce a broad scattering halo instead; (ii) the non-crystalline solids do not have well defined stoichiometry, thus they can cover a broad range of chemical compositions; (iii) the variability of chemical composition includes the possibility of incorporation of ionic constituents other than aluminum and phosphate ions; (iv) as amorphous solids are thermodynamically meta-stable, they may demonstrate a tendency to undergo spontaneous morphological, chemical and structural changes; and (v) the chemical composition of crystalline particle surface is highly uniform while the chemical composition of surface of amorphous particles may show large or small differences, either abrupt or gradual. In addition, while particles of crystalline solids tend to grow by the well-known mechanism of Ostwald ripening, non-crystalline particles may expand or swell and shrink (de-swell) by water sorption and desorption, forming a gel-like or plastic material that is easily deformed when subjected to shearing, compression or capillary forces.

The aluminum phosphate, aluminum metaphosphate, aluminum orthophosphate and aluminum polyphosphate particles used in the coating compositions may be generally characterized by several different characteristics. For example, the aluminum phosphate, aluminum metaphosphate, aluminum orthophosphate and aluminum polyphosphate particles, when prepared in powder form, include particles of which some of the particles have at least one void per particle, on the average. In addition, when the aluminum phosphate, polyphosphate and/or metaphosphate is in powder form, samples subjected to a differential scanning calorimetry test will demonstrate two distinct endothermic peaks, said peaks occurring generally between 90° Celsius and 250° Celsius. In certain embodiments, the first peak occurs at approximately between the temperatures of approximately 96° Celsius and 116° Celsius, and the second peaks occurs at approximately between the temperatures of 149° Celsius and 189° Celsius. In other embodiments, the two peaks occur at approximately 106° Celsius and approximately 164° Celsius. In addition, the aluminum phosphate typically exhibits excellent dispersibility characteristics, as described herein.

In certain embodiments, the amorphous aluminum phosphate or polyphosphate for use in the coating compositions provided herein further comprises an ion, such as sodium, potassium or lithium ion. In one embodiment, the amorphous aluminum phosphate or polyphosphate further comprises sodium. In certain embodiments, the amorphous aluminum phosphate or polyphosphate is characterized by a skeletal density of between 1.95 and 2.50 grams per cubic centimeter. In certain embodiments, the amorphous aluminum phosphate or polyphosphate is characterized by a skeletal density about 1.95, 2.00, 2.10, 2.20, 2.30, 2.40 or 2.50 grams per cubic centimeter. In certain embodiment, amorphous aluminum phosphate or polyphosphate has a phosphorus to aluminum mole ratio of greater than 0.8 to 1.3. In certain embodiment, amorphous aluminum phosphate or polyphosphate has a phosphorus to aluminum mole ratio of greater than 0.9 to 1.3. In certain embodiment, amorphous aluminum phosphate or polyphosphate has a phosphorus to aluminum mole ratio of about 0.8, 0.9, 1.0, 1.1, 1.2 or 1.3. In certain embodiment, amorphous aluminum phosphate or polyphosphate has a sodium to aluminum mole ratio of about 0.6 to 1.4. In certain embodiment, amorphous aluminum phosphate or polyphosphate has a sodium to aluminum mole ratio of 0.6, 0.7, 0.76, 0.8, 0.9, 1.0, 1.1, 1.2 or 1.3.

In one embodiment, the aluminum phosphate or polyphosphate for use in the coating compositions provided herein is in a powder form and, for example, has one to four voids per particle of amorphous aluminum phosphate or polyphosphate powder. The amorphous aluminum phosphate or polyphosphate powder shows this tendency to form closed voids, or hollow particles, to an extent that has not been previously observed for aluminum phosphates, polyphosphates or any other particles. In some embodiments, the particles of aluminum phosphate, polyphosphate or metaphosphate are substantially free of open pores while containing a number of closed pores. The powder form of the product may comprise an average individual particle radius size of between 10 and 80 or 20 and 80 nanometers. In one aspect the powder form of the product may comprise an average individual particle radius size of between 10 to 70, 10 to 60, 10 to 50, 10 to 40, 10 and 30 or 10 and 20 nanometers. In one aspect the powder form of the product may comprise an average individual particle radius size of between 20 to 70, 20 to 60, 20 to 50, 20 to 40, or 20 and 30 nanometers.

In certain embodiments, the particle size of aluminum phosphate particles is controlled to maximize the light scattering. In certain embodiments, particle size determination is done by static light scattering in a Cilas model 1064 instrument. In certain embodiments, the amorphous aluminum phosphate or polyphosphate is characterized by particle size distribution between about 0.1 to about 5 microns. In one embodiment, the amorphous aluminum phosphate or polyphosphate is characterized by a particle size distribution between about 0.2 to about 0.6 microns, about 0.6 to about 1.0 microns, about 1.0 to about 1.5 microns, about 1.0 to about 3.0 microns or about 1.60 to about 3.82 microns. In certain embodiments, the aluminum phosphate provided herein is micronized in a hammer mill to particle size within 3 microns (d10) and 19 microns (d90). In one embodiment, particle size for highly dilute, sonicated samples is 0.1 micron, in a dynamic light scattering instrument (Brookhaven ZetaPlus).

Generally, the amount of aluminum phosphate, aluminum metaphosphate, aluminum orthophosphate and/or aluminum polyphosphate pigment present in the coating compositions described herein may vary greatly depending upon the desired properties in the final coated paper product. In certain embodiments, the aluminum phosphate, aluminum metaphosphate, aluminum orthophosphate and/or aluminum polyphosphate pigment provided herein is used in the composition in an amount of greater than about 1%, 3%, 5%, 7%, 10%, 12%, 15%, 20%, 25%, 30%, 35%, 40% or 50% by total weight of solids in the coating composition. In certain embodiments, the aluminum phosphate, aluminum metaphosphate, aluminum orthophosphate and/or aluminum polyphosphate pigment provided herein is used in the composition in an amount of from about 1% to about 45%, 3% to about 40%, 5% to 30%, 5% to 20% by total weight of solids.

In certain embodiments, the coating compositions described herein are aqueous compositions. The compositions include water in an amount sufficient to provide the composition with desired flowability properties. That is, the coating composition should be sufficiently flowable to allow it to be applied to a paper substrate and form a continuous coating on the paper substrate. In certain embodiments, water in the composition is in an amount of greater than about 10%, 20%, 30%, 40%, 50% or 60% by total weight of the composition. In certain embodiments, the water present in the composition is in an amount of between about 10 weight % and 70 weight %, between about 20 weight % and about 60 weight %, between about 30 weight % and about 60 weight %.

Without being bound to any particular theory, it is believed that the amorphous aluminum phosphate, aluminum metaphosphate, aluminum orthophosphate and/or aluminum polyphosphate pigment used in the coated papers provided herein is deformable, so it flows with the binder, such as latex, used in the composition, and takes on the shape needed to fill the holes in the paper coating that gives a smooth surface (glossing). It is further believed that the pigment has absorbed surface water that is released during the thermal exposure and calendering (pressure) that exposes the strong bonding nature of the surface to latex.

The aluminum phosphate, aluminum metaphosphate, aluminum orthophosphate and/or aluminum polyphosphate pigment used in the coated paper and paper product provided herein can be prepared by methods known to one of skill in the art including methods described in U.S Pub. Nos. 2006/045831 and U.S Pub. Nos. 2006/0211798 and International Publication No. WO 2008/017135, which are all hereby incorporated by reference in their entirety. For example, U.S Pub. Nos. 2006/045831 and U.S Pub. Nos. 2006/0211798 disclose a method for making amorphous aluminum phosphate by combining phosphoric acid with aluminum sulfate and an alkaline material such as sodium hydroxide, while International Publication No. WO 2008/017135 discloses a method for making amorphous aluminum phosphate by using a different process; namely, one comprising combining the use of sodium aluminate. In one example embodiment, the amorphous aluminum phosphate is prepared using a two-step process of combining phosphoric acid and aluminum hydroxide to yield an acidic aluminum phosphate solution or suspension, and then neutralizing the solution or suspension by the addition of sodium aluminate. In another example embodiment, the amorphous aluminum phosphate is prepared by reacting phosphoric acid, aluminum hydroxide and sodium aluminate in a single step.

Base Paper

Suitable base papers for preparing the coated paper include, a thin paper, a kraft paper, a high-quality paper, cotton fiber paper, a baryta paper, recycled and unbleached paperboard, and bleached paperboard, and wet-end paper pulp or wet-end paper sheets, including natural cellulosic, recycled or synthetic fiber pulp or sheets formed therefrom. The phrase “paper laminate” means paper comprising two or more paper layers or lamina.

The base paper can be produced from suitable components known to one of skill in the art, for example, chemical pulps, such as, kraft pulp (KP), sulfite pulp, mechanical pulps, for example, stone groundwood pulp (SGP), refiner groundwood pulp (RGP), thermo mechanical pulp, chemi thermo mechanical pulp and bleached chemi thermo mechanical pulp, waste paper pulps, for example, deinking pulps, and non-wood pulps, for example, bagasse, esparto, kenaf, bamboo, straw, flax and jute pulps. Also, the pulps may be used in combination with at least one member selected from synthetic organic fibers, for example, polyamide and polyester fibers, regenerated fibers, for example, polynosic fibers, and inorganic fibers, for example, glass, ceramic and carbon fibers. In certain embodiments, chlorine-free pulps, for example the ECF (Elemental Chlorine Free) pulp and TCF (Totally Chlorine Free) pulp are employed as pulp for forming the base paper.

Additives

The aluminum phosphate compositions used in the coated papers provided herein can include one or more conventional additives to improve the performance of the composition. Suitable additives, for example, can be selected from binders, lubricants, dispersants, eveners, defoamers, wetting agents, optical brighteners, biocides, cross-linkers, water retention aids, viscosity modifiers or thickeners, and combinations thereof. Various components used in the compositions are described in Lehtinen, Esa, Pigment Coating and Surface Sizing of Paper, Helsinki: Fapet Oy, 2000. The entire disclosure of this publication is incorporated herein by reference.

In certain of the coating compositions provided herein, the additives present are included in the compositions as “parts per hundred parts of aluminum phosphate, aluminum metaphosphate, aluminum orthophosphate and/or aluminum polyphosphate pigment”; that is, the amounts of binder and various other additives are referenced against the amount of pigment present. In certain embodiments, the reference to parts per hundred is to the total amount of all of the pigments in the formulation, including the aluminum phosphate pigment. The amount of binder present in the compositions described herein may vary greatly depending upon the desired properties in the final paper product. One skilled in the art can determine a suitable amount of binder for a desired application based on the knowledge available in the art and disclosure herein.

Binders

In one embodiment, the compositions provided herein further comprise a binder or an adhesive. The binder improves the properties of the coated paper both during the coating process and after the coating process, when printing processes are run. Specifically, during the coating process, the binder provides cohesion of all coating components in the dried coating and adhesion of the coating to the paper web. Further, the binder, along with water, serves as a carrier for the pigment and influences the rheological behavior and water retention of the composition during the coating procedure. In certain embodiments, the binder is present in an amount of from about 1 parts (per hundred parts pigment) to about 30 parts (per hundred parts pigment), in another embodiment, from about 5 parts (per hundred parts pigment) to about 25 parts (per hundred parts pigment).

Suitable binders for use in the compositions provided herein include, for example, proteins, starches, gums, resins, emulsion polymers such as latexes, casein, polyvinyl alcohol, and combinations thereof. Suitable proteins for use as binder in the composition include soy proteins and casein. Suitable starches for use as binder in the composition include corn starch, tapioca, white potato, sorghum, waxy corn, waxy sorghum, sweet potato, rice, and wheat starch. Suitable latex emulsion polymers include styrene butadiene rubber, styrene acrylate, styrene acrylonitrile, vinyl acrylate, acrylic, polyvinyl acetate, and combinations thereof. Another suitable binder is biopolymer nanoparticle latex made from starch as described in U.S. Pat. No. 6,825,252.

The resins for compositions include monomers or polymers or combinations thereof that are compatible with the coating and the end use application. Suitable resins include, but are not limited to, polyester, polyurethane, polyacrylic resins, polyester-epoxy resins or combinations thereof. Suitable polyester resins can be obtained, for example, by polymerization-condensation reaction between a polybasic saturated acid or an anhydride thereof and a polyalcohol. Examples of epoxy resins include, but are not limited to, Bisphenol-A resins, novolac epoxy resins, cyclic epoxy resins or combinations thereof. In certain embodiments, acrylic resins can be obtained by copolymerization of functional monomers like acrylic acid and various copolymerizable monomers, such as for example, unsaturated olefinic monomers, such as ethylene, propylene and isobutylene, aromatic monomers such as styrene, vinyltoluene, alpha-methyl styrene, esters of acrylic and methacrylic acid with alcohols having from 1 to 18 carbon atoms, such as methyl acrylate, methyl methacrylate, ethyl acrylate, ethyl methacrylate, propyl acrylate, propyl methacrylate, n-butyl acrylate, n-butyl methacrylate, isobutyl acrylate, isobutyl methacrylate, cyclohexyl acrylate, cyclohexyl methacrylate, lauryl acrylate, lauryl methacrylate, vinyl esters of carboxylic acids having 2 to 11 carbon atoms, such as vinyl acetate, vinyl propionate, vinyl-2-ethylhexylacrylate or other co-monomers such as vinyl chloride, acrylonitrile and methacrylonitrile. Some examples of polyurethane resins include, but are not limited to, blocked urethane polymers obtained by polycondensation of isocyanates with various polyols.

In one embodiment, resins include acrylic resin containing at least one hydroxyl group and one epoxy group per molecule. Such acrylic resins can be obtained, for example, by copolymerizing a hydroxyl-containing polymerizable monomer, epoxy-containing polymerizable monomer, acrylic polymerizable monomer, and if necessary still other polymerizable monomer(s). A hydroxyl-containing polymerizable monomer is a compound containing at least one hydroxyl group and polymerizable double bond per molecule, examples of which include 2-hydroxyethyl acrylate, 2-hydroxyethyl methacrylate, hydroxypropyl acrylate, hydroxypropyl methacrylate, hydroxybutyl acrylate, hydroxybutyl methacrylate or hydroxyalkyl (meth)acrylates which are obtained by reacting the foregoing with lactones. An epoxy-containing polymerizable monomer is a compound containing at least one each of epoxy group and polymerizable double bond per molecule, examples of which include glycidyl acrylate, glycidyl methacrylate and allylglycidyl ether. Acrylic polymerizable monomers include monoesterified products of acrylic acid or methacrylic acid with C₁-C₂₀ monoalcohols, specific examples including methyl acrylate, ethyl acrylate, propyl acrylate, butyl acrylate, hexyl acrylate, 2-ethylhexyl acrylate, stearyl acrylate, lauryl acrylate, cyclohexyl acrylate, methyl methacrylate, ethyl methacrylate, propyl methacrylate, butyl methacrylate, hexyl methacrylate, 2-ethylhexyl methacrylate, stearyl methacrylate, lauryl methacrylate and cyczxzselohexyl methacrylate. Furthermore, C₂-C₂₀ alkoxyalkyl esters of acrylic acid or methacrylic acid can also be used as the acrylic polymerizable monomers.

### Lubricants

The lubricants for use in the compositions comprise polyoxyalkylene mono- or di-esters or mixtures thereof of phosphoric acid, or a polyoxyalkylene mono- or di-ester or mixtures thereof of phosphoric acid salts, fatty acids, alkali metal salt of fatty acids, or alkaline earth metal salt of fatty acids, sulfonated oils, amines, calcium or ammonium stearates, ureas, ethoxylated glycerol, ethoxylated propoxylated glycerol. letchitin oleate and appropriate emulsifiers. In one embodiment, the lubricant is present in an amount up to about 2%, 1.5% or 1% by weight of the aluminum phosphate, aluminum metaphosphate, aluminum orthophosphate and/or aluminum polyphosphate pigment.

Dispersing Agents

The dispersing agents for use herein comprise a salt and/or ester of: (i) an amine, alcohol, and/or alkanol amine and (ii) an inorganic and/or organic polyprotic acid, wherein the mole ratio of the amine, alcohol, and/or alkanol amine to the polyprotic acid is greater than 3:1. In various embodiments, the mole ratio of amine, alcohol, and/or alkanol amine to polyprotic acid is 4:1 to about 20:1. This mole ratio allows for the production of pigments having improved stability, hiding power, tinting strength, and/or gloss.

One or more amines, alcohols and/or alkanol amines suitable for use in making the dispersing agent include, but are not limited to, amino alcohols, diols, triols, aminopolyols, polyols, primary amines, secondary amines, tertiary amines, quaternary amines or a combination thereof. In one embodiment, the amines and/or alcohols include, but are not limited to, triethylamine, diethylamine, ethylene diamine, diethanolamine, triethanolamine, 2-amino-2-methyl-1-propanol, 1-amino-1-butanol, 1-amino-2-propanol, 2-amino-2-methyl-1,3-propanediol, 2-amino-2-ethyl-1,3-propanediol, 2-amino-2-hydroxymethyl-1,3-propanediol, methanol, isopropyl alcohol, butanol, methoxypropanol, trimethylolethane, trimethylolpropane, pentaerythritol, ethylene glycol, propylene glycol, or a combination thereof.

The one or more polyprotic acids suitable for use in making the dispersing agent include, but are not limited to, phosphoric acid, polyphosphoric acid, phosphonic acid, phosphinic acid, metaphosphoric, pyrophosphoric acid, hypophosphoric acid, phosphorous pentaoxide, other phosphorus acid derivatives, or derivatives of any phosphorous containing acids or combinations thereof.

In one embodiment, the dispersing agent for use in the coating compositions herein is sodium polyacrylate.

In various embodiments, the dispersing agent, when added to a pigment, imparts viscosity stability and resistance to flocculation for the pigment. Typically, the dispersing agent is present in the composition in weight percentages of up to about 5% based on the weight of the aluminum phosphate, aluminum metaphosphate, aluminum orthophosphate and/or aluminum polyphosphate pigment. In one embodiment, the dispersing agent is present in amounts of from about 0.01 to about 3%, 0.01 to about 2%, or 0.01 to about 1%, based on the weight of the aluminum phosphate, aluminum metaphosphate, aluminum orthophosphate and/or aluminum polyphosphate pigment.

Mixing the dispersing agent with the aluminum phosphate, aluminum metaphosphate, aluminum orthophosphate and/or aluminum polyphosphate pigment can be accomplished by mixing methods known in the art. Thus, the mixing may be accomplished, for example, with a blender or any other high-speed mixing device. Blade speeds of 50 rpm or higher, for example 1000 rpm to 3000 rpm, are generally used for mixing.

Defoamers

The defoamers for use in the compositions include, but are not limited to blends of surfactants, tributyl phosphate, fatty polyoxyethylene esters plus fatty alcohols, fatty acid soaps, silicone emulsions and other silicone containing compositions, waxes and inorganic particulates in mineral oil, vegetable oils, blends of emulsified hydrocarbons and other compounds sold commercially to carry out this function. Such antifoamers/defoamers may be used in amounts up to about 1% by weight.

Cross Linkers

The cross linkers for use include, for example, glyoxals, glyoxalated resins, melamine formaldehyde resins, and ammonium zirconium carbonates. In one embodiment, the cross linker is present in amount up to about 5%, 4%, 3%, 2% or 1% by weight of the aluminum phosphate, aluminum metaphosphate, aluminum orthophosphate and/or aluminum polyphosphate pigment.

Water Retention Aids

The water retention aids for use herein include, for example, sodium carboxymethyl cellulose, hydroxyethyl cellulose, PVOH (polyvinyl alcohol), starches, proteins, polyacrylates, gums, alginates, polyacrylamide bentonite and other commercially available products sold for such applications. In one embodiment, the water retention aid is present in amount up to about 2%, 1.5% or 1% by weight of the aluminum phosphate, aluminum metaphosphate, aluminum orthophosphate and/or aluminum polyphosphate pigment.

Viscosity Modifiers

The viscosity modifiers and/or thickeners for use herein include, for example, acrylic associative thickeners, polyacrylates, emulsion copolymers, dicyanamide, triols, polyoxyethylene ether, urea, sulphated castor oil, polyvinyl pyrrolidone, CMC (carboxymethyl celluloses, for example sodium carboxymethyl cellulose), sodium alginate, xanthan gum, sodium silicate, acrylic add copolymers, HMC (hydroxymethyl celluloses), HEC (hydroxyethyl celluloses) and others. In one embodiment, the viscosity modifiers and/or thickeners may be used in amounts up to about 2%, 1.5% or 1% by weight of the aluminum phosphate, aluminum metaphosphate, aluminum orthophosphate and/or aluminum polyphosphate pigment.

Dry or Wet Pick Improvement Additives

In certain embodiment, the compositions comprise one or more dry or wet pick improvement additives. Such additives may be used in amounts up to about 2% by weight, and include, for example, e.g., melamine resin, polyethylene emulsions, urea formaldehyde, melamine formaldehyde, polyamide, calcium stearate, styrene maleic anhydride and others.

Dry or Wet Rub Improvement and/or Abrasion Resistance Additives

In certain embodiment, the compositions comprise one or more dry or wet rub improvement and/or abrasion resistance additives. Such additives may be used in amounts up to about 2% by weight, and include, for example, glyoxal based resins, oxidised polyethylenes, melamine resins, urea formaldehyde, melamine formaldehyde, polyethylene wax, calcium stearate and others.

Gloss-Ink Hold-Out Additives

In certain embodiment, the compositions comprise one or more gloss-ink hold-out additives. Such additives may be used in amounts up to about 2% by weight, and include, for example, oxidised polyethylenes, polyethylene emulsions, waxes, casein, guar gum, CMC, HMC, calcium stearate, ammonium stearate, sodium alginate and others.

Optical Brightening Agents

In certain embodiment, the compositions comprise one or more optical brightening agents (OBA) and/or fluorescent whitening agents (FWA). Such agents may be used in amounts up to about 1% by weight, and include, for example, stilbene derivatives. In certain embodiments, PVOH is used as an OBA carrier to improve the performance of stilbene OBA.

Biocides/Spoilage Control Agents

In certain embodiment, the compositions comprise one or more biocides/spoilage control agents. Such agents may be used in amounts up to about 1% by weight, and include, for example, metaborate, sodium dodecylbenene sulphonate, thiocyanate, organosulphur, sodium benzonate and other compounds sold commercially for this function, e.g., the range of biocides sold by Nalco.

Leveling and Evening Aids

In certain embodiment, the compositions comprise one or more leveling and evening aids. Such aids may be used in amounts up to about 2% by weight, and Include, for example, non-ionic polyol, polyethylene emulsions, fatty acid, esters and alcohol derivatives, alcohol/ethylene oxide, sodium CMC (caboxy methyl cellulose), HEC (hydroxyl ethyl cellulose), alginates, calcium stearate and other compounds sold commercially for this function.

Grease and Oil Resistance Additives

In certain embodiment, the compositions comprise one or more grease and oil resistance additives. Such additives may be used in amounts up to about 2% by weight, and include, for example, oxidised polyethylenes, latex, SMA (styrene maleic anhydride), polyamide, waxes, alginate, protein, CMC (carboxymethyl cellulose), HMC (hydroxyl ethyl cellulose) and fluorocarbons.

Water Resistance Additives

In certain embodiment, the compositions comprise one or more water resistance additives. Such additives may be used in amounts up to about 2% by weight, and include, for example, oxidised polyethylenes, ketone resin, anionic latex, polyurethane, SMA, glyoxal, melamine resin, polyamide, glyoxals, stearates and other materials commercially available for this function.

In certain embodiment, the compositions comprise one or more dyes, which may be used in amounts up to about 0.5% by weight.

Additional Pigments

In certain embodiments, the compositions provided herein further include one or more additional pigments, such as calcium carbonate, including ground calcium carbonate (GCC), calcined kaolin, hydrous kaolin, delaminated clay, kaolin clay, China clay, talc, mica, dolomite, silica, silicates, zeolite, gypsum, satin white, titania, titanium dioxide, calcium sulfate, barium sulfate, aluminum trihydrate, plastic pigment, and combinations thereof.

In certain embodiments, the compositions comprise one or more dyes or colored pigments, which may be used in amounts up to about 0.5% by weight.

In certain embodiments, the compositions comprise a combination of aluminum phosphate, aluminum metaphosphate, aluminum orthophosphate and/or aluminum polyphosphate pigment and GCC pigments. In certain embodiments, the compositions comprise a combination of aluminum phosphate, aluminum metaphosphate, aluminum orthophosphate and/or aluminum polyphosphate pigment and titanium dioxide pigments. In one embodiment, the amount of titanium dioxide pigment is about 1%, 3%, 5%, 7%, 10%, 15%, 20%, 25%, 30%, 35%, 50% or more by total weight of solids in the composition. In another embodiment, the ratio of aluminum phosphate, aluminum metaphosphate, aluminum orthophosphate and/or aluminum polyphosphate pigment and titanium dioxide pigment in the compositions is about 1:1, 1.5:1, 2:1, 2.5:1, 3:1, 3.5:1 or 4:1. In another embodiment, the ratio of titanium dioxide pigment and aluminum phosphate, aluminum metaphosphate, aluminum orthophosphate and/or aluminum polyphosphate pigment in the compositions is about 1:1, 1.5:1, 2:1, 2.5:1, 3:1, 3.5:1 or 4:1.

In one embodiment, the amount of aluminum phosphate, aluminum metaphosphate, aluminum orthophosphate and/or aluminum polyphosphate pigment in the compositions is at least about 1%, 3%, 5%, 7%, 10%, 12%, 20%, 25%, 30%, 40%, 50%, 60% or 70% and the amount of GCC pigment is about 5%, 10%, 20%, 30%, 40%, 50%, 60% or 70% by total weight of solids in the composition. In one embodiment, the amount of aluminum phosphate, aluminum metaphosphate, aluminum orthophosphate and/or aluminum polyphosphate pigment in the compositions is at least about 1%, 3%, 5%, 7%, 10%, 12%, 20%, 25%, 30%, 40%, 50%, 60% or 70% and the total amount of one or more other pigments is about 5%, 10%, 20%, 30%, 40%, 50%, 60%, 70% or 80% by total weight of solids in the composition.

In certain embodiments, the combination of aluminum phosphate, aluminum metaphosphate, aluminum orthophosphate and/or aluminum polyphosphate pigment and titanium dioxide pigment increases both gloss and opacity of the coated paper.

Any of the above additives and additive types may be used alone or in admixture with each other and/or with other additives, if desired.

The total solids content of the compositions provided herein is typically at least about 50% solids by weight, in certain embodiments at least about 60%, in certain embodiments at least about 70%, and as high as considered suitable by one of skill in the art but still giving a suitably fluid composition which may be used in coating. In certain embodiment, the total solids content of the compositions is about 55%, 60%, 61%, 62%, 63%, 64%, 65%, 66%, 67%, 68%, 69%, 70%, 72%, 75%, or 80%.

Preparation of the Coating Compositions

According to another aspect, provided herein is a method for preparing the aluminum phosphate compositions for coating a paper, which method comprises mixing the aluminum phosphate, aluminum metaphosphate, aluminum orthophosphate and/or aluminum polyphosphate pigment, a binder and any other optional additional constituents in an aqueous liquid medium to prepare a suspension of the solid components therein. The composition may suitably be prepared by conventional mixing techniques, as will be well known to one of ordinary skill in this art.

Paper Coating Process

According to another aspect, provided herein is a method of preparing a coated paper, which comprises applying the composition to coat a base paper, drying the coating, and calendering the paper to form a coated paper surface, e.g., a gloss coating, thereon. The coating may be formed on both sides of the paper.

In the calendering step, the paper smoothness and gloss is improved and bulk is reduced by passing a coated paper sheet between calender nips or rollers one or more times. Usually, elastomeric coated rolls are employed to provide smoothing and burnishing of the coated paper surface. In certain embodiments, an elevated temperature is applied. One or more (e.g. up to about 12, or sometimes higher) passes through the nips may be applied.

Methods of coating paper and other sheet materials, and apparatus for performing the methods, are widely published and well known. Such known methods and apparatus may conveniently be used for preparing coated paper provided herein. For example, a review of such methods published in Pulp & Paper International, May 1994, page 18 et seq, incorporated in its entirety by reference. (This is a badly outdated and incomplete reference.)

Paper sheets may be coated in line on the paper machine, i.e., “on-machine,” or “off-machine” on a coater or coating machine. Use of high solids compositions is desirable in the coating method because it leaves less water to evaporate subsequently. However, as is well known in the art, the solids level should not be so high that high viscosity and leveling problems are introduced.

The methods of coating can be performed using apparatus comprising (i) an application for applying the coating composition to the paper to be coated; and (ii) a metering device for ensuring that a correct level of coating composition is applied. When an excess of coating composition is applied to the applicator, the metering device is downstream of it. Alternatively, the correct amount of coating composition may be applied to the applicator by the metering device, e.g., as a film press. At the points of coating application and metering, the paper web support ranges from a backing roll, e.g., via one or two applicators, to nothing (i.e., just tension). The time the coating is in contact with the paper before the excess is finally removed is the dwell time—and this may be short, long or variable.

The coating layer may be formed on both the front and back surfaces of the base paper and/or in a multi-layered structure. The multi-layered coating layer can be formed by forming one or more intermediate coating layers on a surface of the base paper, and an outermost coating layer is formed on the intermediate coating layer or layers. When the coating layer is formed on the two surfaces of the base paper or in the multi-layered structure, the coating compositions and amount of a plurality of the coating layers may be the same as each other or different from each other. The composition of each coating liquid may be designed in consideration of the purpose and the desired properties of the coating layer. When the coating layer is formed on only a front surface of the base paper, the back surface of the base paper may be coated with a synthetic resin layer, a pigment-binder mixture layer, or an anti-static layer. The above-mentioned back coating layer contributes to enhancing a resistance to curling, the printing-applicability and a resistance to blocking of feeding and/or delivering of the coated paper into or from the printer. The back surface of the base paper may be treated with an adhesive, a magnetic material, a flame retardant agent, a thermal resistant agent, a water-proofing agent, an oil-proofing agent or an anti-slipping agent to impart a desired function to the back surface of the coated paper.

The compositions provided herein can be applied to one or more sides of the base paper by any means known in the art. For example, paper coating methods include, but are not limited to, roll applicator and metering with roll, rod, blade, bar, air knife; pond applicator and metering with roll, rod, blade, bar, or air knife; fountain applicator and metering roll with roll, rod, blade, bar, or air knife; pre-metered films or patterns, such as gate roll, three-roll, anilox, gravure, film press, curtain, spray; and foam application. In one embodiment, the paper product is fed through a rolling nip in which one of the rolls has been previously coated with the composition. The composition is transferred to the paper product's surface. The excess composition is removed from the surface of the paper product using a steel trailing blade which creates a level coating profile on the surface of the sheet of the desired final add-on coating weight.

In certain embodiments, the composition is applied to the paper product in an amount of from about 1 g/m² to about 30 g/m². In other embodiments, the composition is applied to the paper product in an amount of from about 3 g/m² to about 25 g/m² or from about 5 g/m² to about 20 g/m².

The Coated Paper

The coated paper provided herein is suitable for a variety of printing applications like Giclee printing, color copying, xerography, screen printing, gravure, dye-sublimation, flexography, inkjet printing, web offset printing, electrophotographic printing, image recording paper for the thermal transfer recording, ink jet recording, etc.

In one aspect, provided herein are ink jet papers and digital printing papers comprising the aluminum phosphate compositions.

In another aspect, provided herein is a coated linerboard for direct post print flexography to prevent smudging and to improve image fidelity comprising the aluminum phosphate compositions.

In another aspect, provided herein is an ultra lightweight coated publication paper.

It is yet another aspect, provided herein is gravure printing paper comprising the aluminum phosphate compositions.

In certain embodiments, the coated paper provided herein has a coating gloss equal to or greater than about 10% at 75° measured by TAPPI test method T480 om-92. This method measures the specular gloss of the paper at 75° from the plane of the paper. In other embodiments, the coated paper provided herein has a coating gloss equal to or greater than about 20%, 30%, 40%, 50%, 55%, 60%, 65%, 70%, 75%, 80% at 75°. In one embodiment, the coating gloss at 75° is from about 25% to about 75%. In another embodiment, the coating gloss is from about 30% to about 65% at 80°.

In certain embodiments, the coated paper provided herein has a smoothness of less than 5.0, 4.0 or 3.0 as measured using TAPPI test method for Parker Print Surface: T555 om-99. In one embodiment, the coated paper has Parker Print Surface from about 1.0 to about 2.5, from about 0.90 to about 2.25 or from about 0.90 to about 2.0.

In certain embodiments, the coated paper has an opacity of greater than 80% as measured using TAPPI test method T425 om-91. In one embodiment, the coated paper has opacity from about 80% to about 99%. In another embodiment, the opacity is from about 85% to about 99%, about 90% to about 99%, about 92% to about 99% or about 94% to about 99%.

In certain embodiments, the brightness of the coated paper is greater than about 70%, 73%, 75%, 77%, 80%, 85% or 90% GE brightness as measured using TAPPI test method T452 om 92. In one embodiment, the coated paper has brightness from about 70% brightness to about 95% GE brightness as measured using TAPPI test method T452 om 92. In another embodiment, the brightness is from about 80% brightness to about 99% GE brightness, or from about 85% brightness to about 99% GE brightness.

In one aspect, the aluminum phosphate compositions used in the coated paper provided herein have improved rheology compared to silica and/or other specialty pigments. In certain embodiments, the aluminum phosphate compositions improve coater runnability and/or improve energy consumption in drying. In other embodiments, the aluminum phosphate compositions are in form of water slurries with a higher percentage of solids and good shear thinning rheology compared to existing compositions. Thus, the aluminum phosphate compositions provided herein result in faster on-machine drying rates because of higher percent solid coatings than existing compositions which results in lower drying costs and reduced print smear.

In certain embodiments, the aluminum phosphate compositions have enhanced on-machine coating runability and therefore enhanced production rates over existing compositions. In other embodiments, the aluminum phosphate compositions have low Einlehner abrasion which results in reduced wear to process equipment and no metallic marks are left on the paper by the gripper bars.

In one embodiment, the aluminum phosphate compositions herein comprise higher composition solids compared to existing compositions. In another embodiment, the aluminum phosphate compositions provided herein have a low bulk density.

In another embodiment, the aluminum phosphate compositions provided herein coat paper with essentially no dusting, have improved optical/reflective densities of four-color cyan, magenta, yellow, black (CMYK) ink jet print.

In yet another embodiment, the aluminum phosphate compositions provided herein make lighter coat weights possible because of internal void volume.

In certain embodiments, the aluminum phosphate compositions provided herein have improved ink jet print density, improved ink receptivity in printing papers and/or improved opacity.

In one embodiment, the aluminum phosphate compositions provided herein have less soak-in and reduced roughening of the base sheet during application which results in a smoother coated sheet.

In another embodiment, the aluminum phosphate compositions provided herein allow higher operating speeds and higher production rates. In yet another embodiment, the aluminum phosphate compositions provided herein have the capability to coat on high speed paper machines rather than only on low speed off machine coating lines which reduces waste and costs.

In one embodiment, the aluminum phosphate compositions provided herein can act as fillers in newsprint to prevent print-through, and as fillers in specialty technical papers such as anti-tarnish, gas filtration, filter, and absorbent papers.

In another embodiment, the aluminum phosphate compositions provided herein are used as microparticulate retention aids, deinking aids in combination flotation-washing systems, or coefficient of friction (COF) control aids in recycled linerboard.

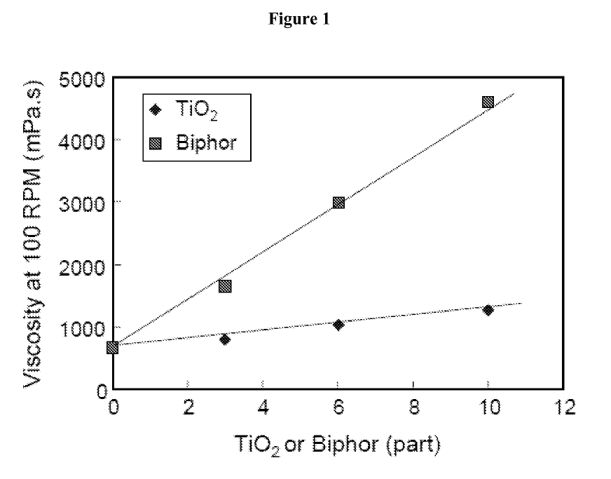

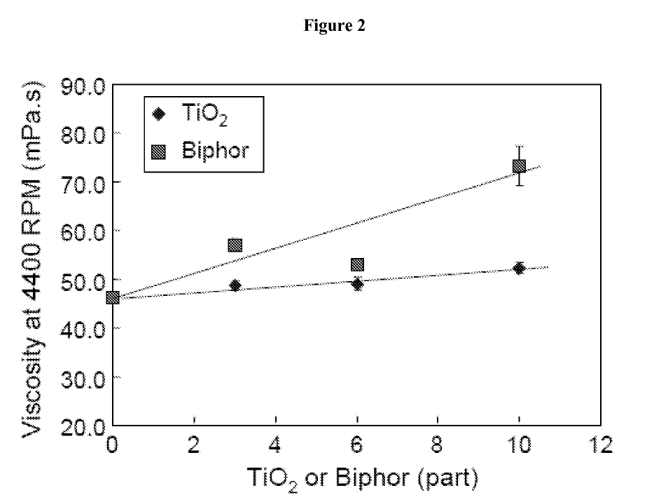

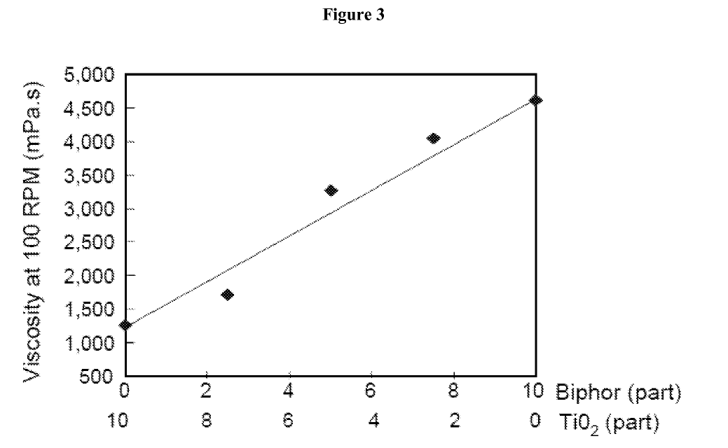

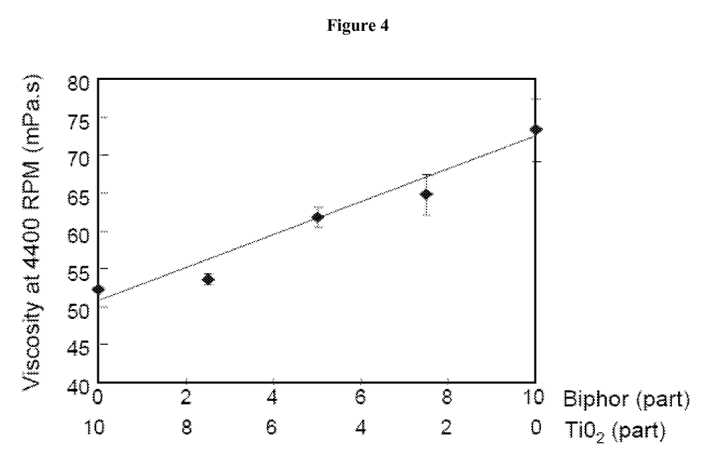

FIGS. 1 and 2 provide comparison of low shear and high viscosities at 100 RPM for coating compositions comprising aluminum phosphate pigments and the titanium dioxide pigments, respectively. FIGS. 3 and 4 provide low shear and high viscosities at 100 RPM for coating formulations obtained by gradually replacing TiO₂ with aluminum phosphate pigments, respectively. As seen from FIGS. 1-4, addition of aluminum phosphate pigment increases both low-shear and high-shear viscosity.

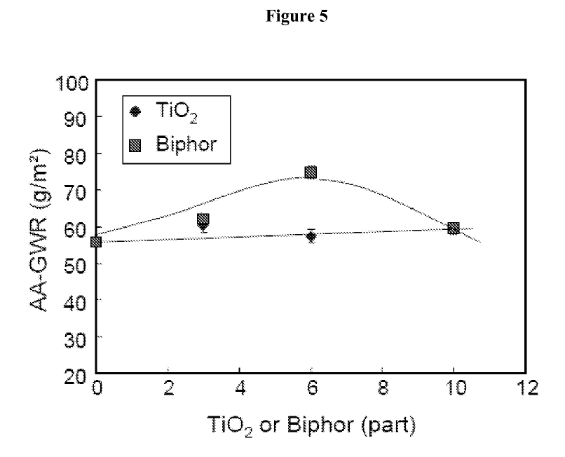

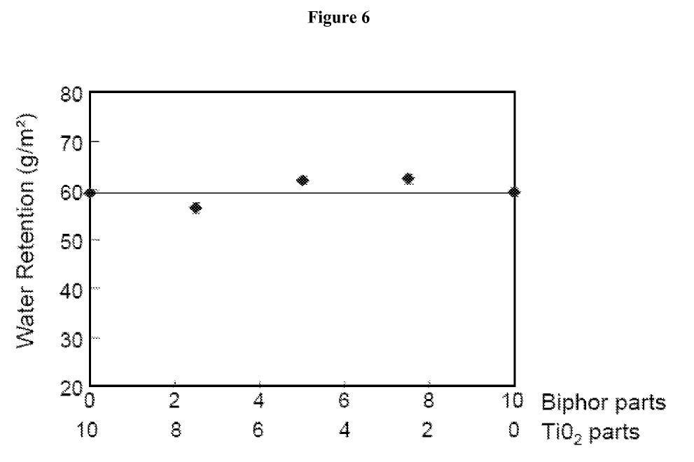

FIG. 5 provides a comparison of water retention property for coating compositions comprising aluminum phosphate pigments and titanium dioxide pigments. FIG. 6 provides impact on water retention of the coating compositions by replacing TiO₂ with aluminum phosphate. As seen, addition of aluminum phosphate had little impact on water retention.

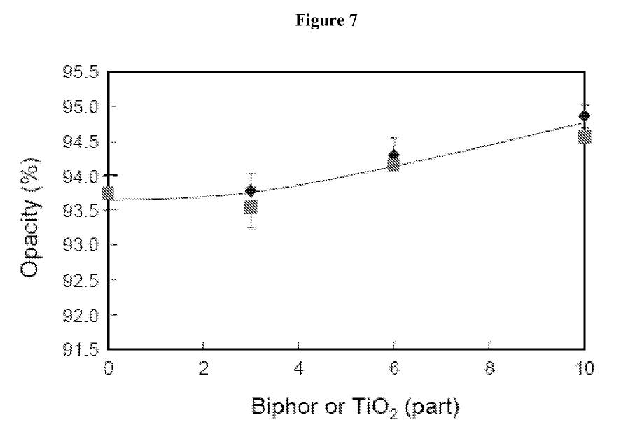

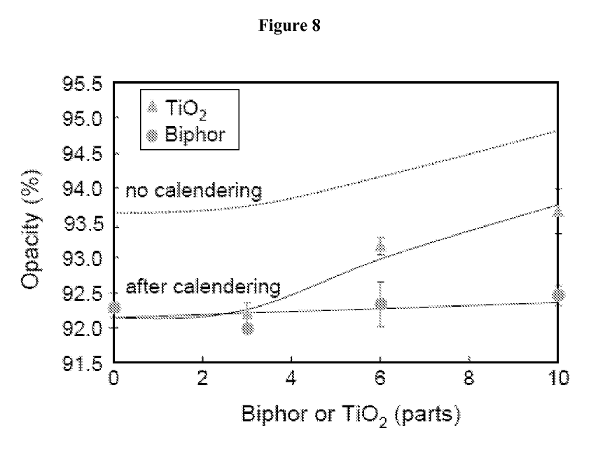

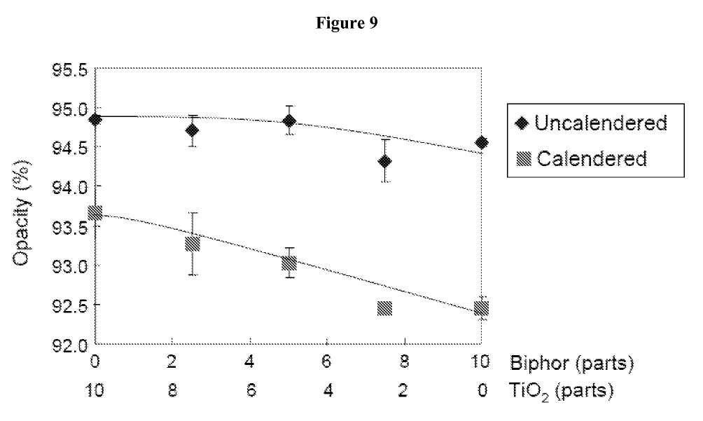

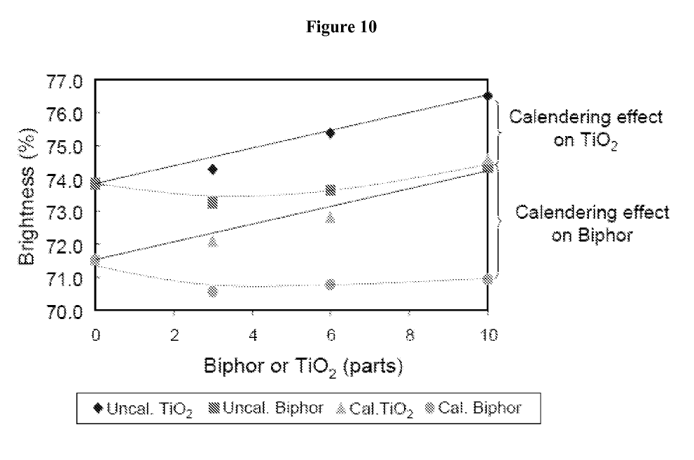

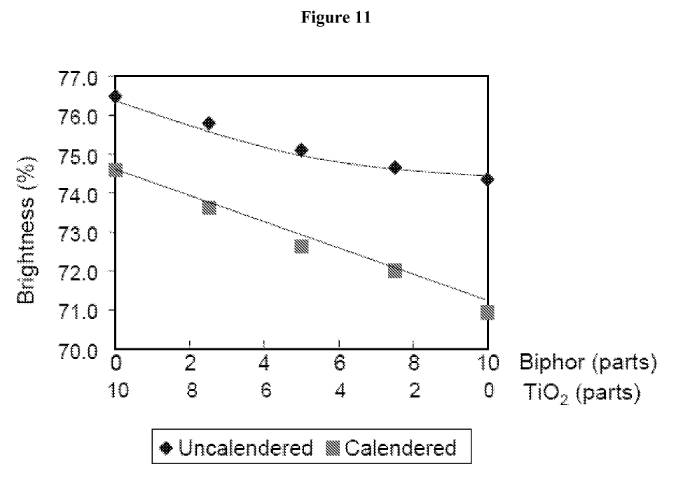

FIGS. 7 and 8 provide comparison of opacity of paper coated with compositions comprising aluminum phosphate pigments and titanium dioxide pigments before and after calendaring, respectively. FIG. 9 provides an impact of replacing TiO₂ with aluminum phosphate pigments on opacity of coated paper. As seen, aluminum phosphate has the same opacifying power as TiO₂, if not calendered. However, opacifying power is reduced with calendaring. FIG. 10 provides a comparison of brightness of paper coated with compositions comprising aluminum phosphate pigments and titanium dioxide pigments before and after calendaring. FIG. 11 provides an impact of replacing TiO₂ with aluminum phosphate pigments on brightness of coated paper. As seen, aluminum phosphate is equal or slightly better than TiO₂ in OBA performance.

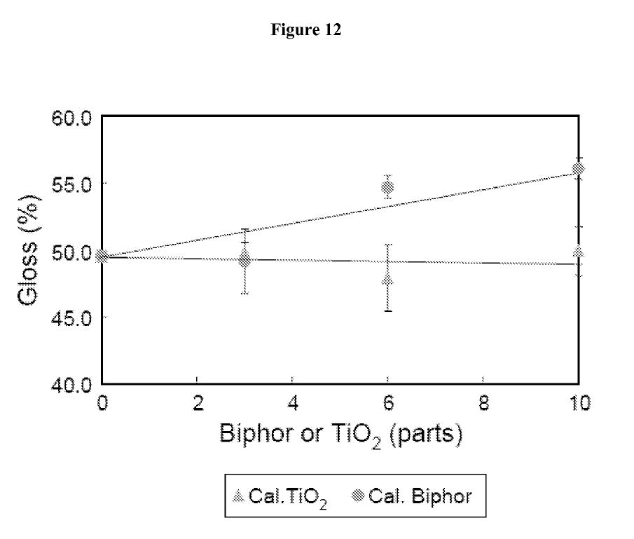

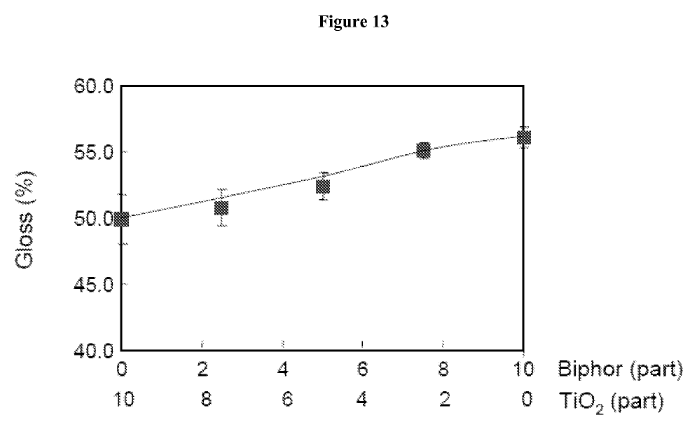

FIG. 12 provides a comparison of gloss of paper coated with compositions comprising aluminum phosphate pigments and titanium dioxide pigments. FIG. 13 provides an impact of replacing TiO₂ with aluminum phosphate pigments on gloss of coated paper. As seen, aluminum phosphate is an excellent glossing pigment and gloss increases with the amount of aluminum phosphate. Thus, in certain embodiments, blending aluminum phosphate with TiO₂ appears to increase both gloss and opacity.

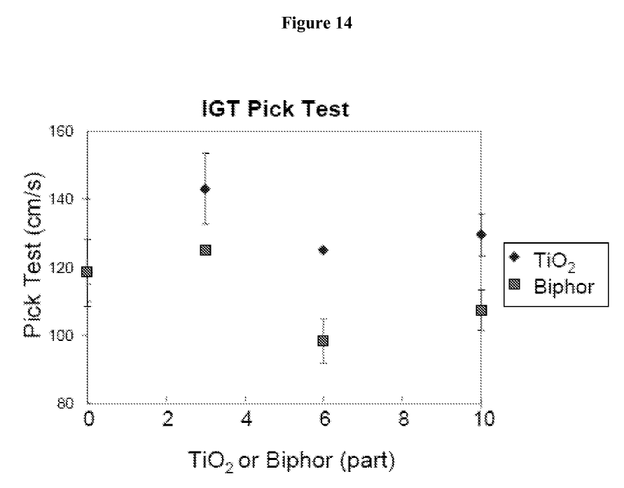

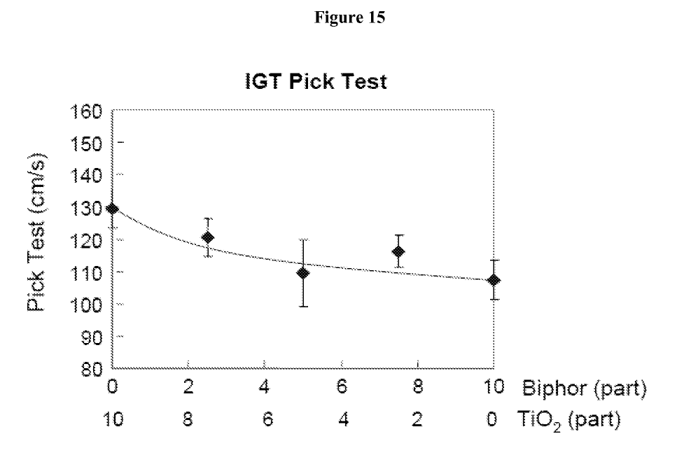

FIG. 14 provides a comparison of surface strength of paper coated with compositions comprising aluminum phosphate pigments and titanium dioxide pigments. FIG. 15 provides a impact of replacing TiO₂ with aluminum phosphate pigments on surface strength of coated paper.

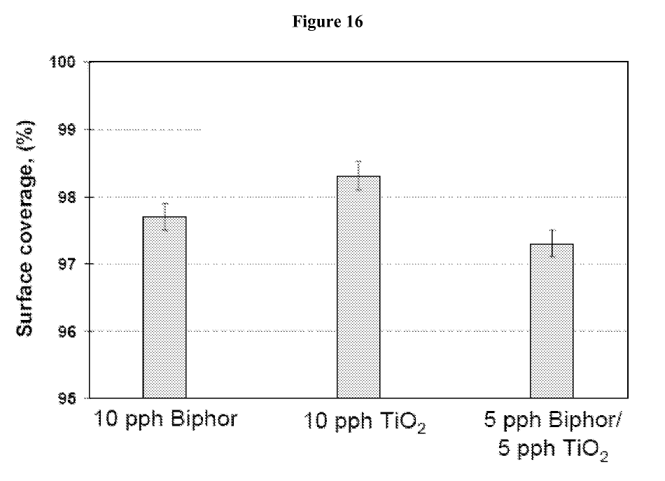

FIG. 16 provides comparison of surface coverage for compositions comprising aluminum phosphate pigments and titanium dioxide pigments. In certain embodiments, use of aluminum phosphate has no significant effect on surface coverage.

High Bulk Coated Paper

In one embodiment, provided herein is a high bulk coated paper which proportionally uses more base stock and less coating composition than similar grades of conventional paper of the same total weight.

For example, while a conventional 30 pounds per ream paper, where herein a ream is 3300 square feet of paper, may have the following properties:

| Base Weight | Coating Weight |
|---|---|
| 22 lbs./rm | 8 lbs./rm |

In one embodiment, the paper provided herein has:

| Base Weight | Coating Weight |
|---|---|
| 25 lbs./rm | 5 lbs./rm |

For a heavier paper of 32 lbs./rm the data is:

| Conventional Base Weight | Conventional Coating Weight |
|---|---|
| 24 lbs./rm | 8 lbs./rm |

In paper provided herein

| Base Weight | Coating Weight |
|---|---|
| 26.5 lbs./rm | 5.5 lbs./rm |

For 38 pound paper:

| Conventional Base Weight | Conventional Coating Weight |
|---|---|
| 27 lbs./rm | 11 lbs./rm |

In paper provided herein

| Base Weight | Coating Weight |
|---|---|
| 31.5 lbs./rm | 6.5 lbs./rm |

The caliper of the papers above are as follows:

| Pound | Caliper Conventional | Caliper paper provided herein |
|---|---|---|
| 30 | 1.5 to 1.65 mils | 1.75 to 1.9 mils |
| 32 | 1.6 to 1.75 mils | 1.85 to 2.0 mils |
| 38 | 1.8 to 2.0 mils | 2.0 to 2.2 mils. |

In certain embodiments, the high bulk coated paper provided herein can be made as described in U.S. Pat. No. 6,254,725, starting with a waterborne furnish having a high percentage of mechanical pulp, generally in excess of 50%, usually in the 55 to 75% range, or about 65%. As used herein, the term mechanical pulp may include stone ground wood (SGW), pressurized ground wood (PGW) and chemi ground wood (CGW), refiner mechanical pulp (RMP), thermal mechanical pulp (TMP), and chemi thermal mechanical pulp (CTMP). Exemplary sample furnish formulations are: (1) 45% TMP/20% SGW/35% softwood Kraft (SWK); (2) 50% TMP/25% PGW/25% SWK and (3) 70-85% CTMP/30-15% SWK.

The furnish is utilized in a papermaking apparatus or machine having a gap former instead of a conventional fourdrinier as described in U.S. Pat. No. 6,254,725. The inherent ability of former gap to reduce two sidedness of the paper base permits achieving minimum coating application with good gloss.

The above made paper then moves into the press section wherein it can be conventionally pressed. The press section may include a wide shoe or extended nip press which is believed to compress the web less than is conventional, resulting in the paper web retaining more bulk and/or caliper. The extended nip press preserves bulk, yet permits water removal from the web due to the extended time the web is in the nip, which permits use of a nip pressure that is lower than conventional. The web is then sent through the dryer section and dried to a moisture content of below 10%, or to 5% or less. The paper may then be coated with the coating compositions comprising aluminum phosphate on or off the papermaking machine.

As noted above, the coating weight applied to the web is less than conventional, but because of the smoothness and uniformity of the gap formed paper base, the paper base can be acceptably coated with a lesser amount of coating, thus yielding high bulk and allowing a given weight paper to proportionally comprise a greater percentage of paper base and a lesser percentage of coating than is conventional. The amount of aluminum phosphate pigment used can be adjusted to obtain the desired bulk and gloss. The coating can be applied to one or both sides of the paper web. The compositions can further contain a plastic pigment and additives as described elsewhere herein.

Generally, the coating can be applied with any conventional type blade coater and such as with a short dwell time applicator as shown in U.S. Pat. Nos. 4,250,211 and 4,512,279, and/or a fountain type coater shown in U.S. Pat. No. 5,436,030 and/or a double bladed coater as shown in U.S. Pat. No. 5,112,653, the teachings of which patents are incorporated herein by reference. In addition, the coating can be applied by a film coater or Speedcoater applicator made by Voith Sulzer GmbH, such as that shown in U.S. Pat. No. 4,848,268. Other suitable types of metering, such as with a doctor rod, grooved or smooth, could also be used.

The coated paper can then be calendered, hot-soft calendered and/or supercalendered.

In one embodiment, provided herein is a high bulk coated paper comprising a base paper of a weight of 18 to 34 pounds per ream and a coating composition on at least one side of the base paper, wherein the composition comprises an amorphous aluminum phosphate or polyphosphate pigment, and the coating composition is of a weight of no more than about 2 or 3 pounds per ream per side, and the base paper has a caliper of at least about 80, 85 or 88% of the total caliper of the coated paper and the coating composition provides substantially the remainder of the caliper of the coated paper, so that the coated paper has a bulk factor of at least 55.

In another embodiment, provided herein is a lightweight high bulk coated paper comprising a base paper of a weight of about 26 to 36 pounds per ream, and a coating composition on at least one side of the base paper, wherein the composition comprises an amorphous aluminum phosphate or polyphosphate pigment, and the coating composition is of a weight no more than about 3 pounds or is of about 1.5 to 3.5 pounds per ream per side, and the base weight and the coating weight being selected so that the base has a caliper of at least about 75, 80, 85 or 88% of the total caliper of the coated paper and the coating composition provides substantially the remainder of the caliper of the coated paper, so that the coated paper has a bulk factor of at least 55.

In yet another embodiment, provided herein is an ultra lightweight high bulk coated paper comprising a base paper base of a weight on the order of about 18 to 24 pounds per ream, and a coating composition on at least one side of the base paper, wherein the composition comprises an amorphous aluminum phosphate or polyphosphate pigment, and the coating composition is of a weight of about 2 pounds per ream per side, and the base weight and the coating weight being selected so that the base has a caliper of at least about 75, 80, 85 or 88% of the total caliper of the coated paper and the coating composition provides substantially the remainder of the caliper of the coated paper, so that the coated paper has a bulk factor of at least 55.

In certain embodiments, the coating composition is applied in substantially equal weights on each side of the base paper. In certain embodiments, the coated paper has a bulk factor of at least 50, 52, 55, 58, 60 or more. The bulk factor can be calculated as described in U.S. Pat. No. 6,254,725. In certain embodiments, the coated paper has a 75° TAPPI gloss of 30, 35, 40 or above.

In certain embodiments, the resultant coated paper has one or more of the following characteristics as compared to conventional coated paper of the same weight: 10-20% less lineal feet/roll of paper for the same roll diameter, evidencing the higher bulk of the paper; lesser weight per roll for the same roll diameter; about 10-20% higher caliper; about 10-15% higher stiffness; about 0.5-1.0 pt. or more gain in opacity and brightness; and print smoothness and gloss equivalent to conventional paper.

The high bulk lightweight coated paper provided herein is desirable for use in magazines which require very low basis weight to reduce paper costs by increasing printing area per ton of paper and by reducing mailing cost per magazine. High bulk paper will improve the economics of publishing magazines by allowing a lower basis weight to be substituted for a higher basis weight conventional grade.

In addition, the increased stiffness of the paper improves paper web rigidity for low basis weight paper which results in better runnability on high speed printing presses and folders used to produce magazines. Further, the thicker paper produces a bulkier magazine which is less flimsy when handled. A bulkier magazine “feels more substantial” i.e., it will not droop or feel limp. Individual pages will separate easier and turn without sticking together

Certain examples of coating formulations are described below. The following examples are presented to exemplify embodiments of the compositions. All numerical values are approximate. When numerical ranges are given, it should be understood that embodiments outside the stated ranges may still fall within the scope of the invention. Specific details described in each example should not be construed as necessary features of the invention.

### EXAMPLES

### Example 1

### Comparison of Aluminum Phosphate Pigment with Plastic Pigment

Coatings were prepared according to Table 1. The GCC (ground calcium carbonate), Hydrocarb 90, was dispersed at 72% solids with a high shear Cowles disperser. The No. 1 clay pigment, Hydrafine, was dispersed at 70% solids. Aluminum phosphate pigment at 34.2% solids was dispersed with the high shear Cowles disperser prior to use. After the pigments were dispersed, the other coating components were added under mild agitation with a mixer in the order listed in Table 1. After combining all the coating components, the solids content of the coating was adjusted with dilution water in an attempt to reach the same target solids content, Table 2. The coating solids and Brookfield viscosity were measured. Brookfield viscosities were measured using a #5 spindle at 100 RPM, 23° C., also in Table 2. The coatings were also tested on a Hercules High shear rheometer with an E bob/20.4 sec ramp time.

TABLE 1
Coating Formulations
Coating Formulations
pph of Ingredients Needed

| Ingredient | Form 1 | Form 2 | Form 3 | Form 4 | Form 5 |
|---|---|---|---|---|---|
| GCC | 60 | 55 | 50 | 55 | 50 |
| No. 1 Clay | 40 | 40 | 40 | 40 | 40 |
| Pigment X | 0 | 5 | 10 | 0 | 0 |
| Plastic Pigment | 0 | 0 | 0 | 5 | 10 |
| SA Latex | 15 | 15 | 15 | 15 | 15 |
| Lubricant | 1 | 1 | 1 | 1 | 1 |
| Dispersant | 0.2 | 0.2 | 0.2 | 0.2 | 0.2 |
| (wet/drypigment) | | | | | |
| Total | 116.2 | 116.2 | 116.2 | 116.2 | 116.2 |

TABLE 2
Solid content and viscosity of coating formulations

| | Content of | |
|---|---|---|
| Coating # | Solids (%) | Viscosity (cp) |
| 1 | 64.70 | 2630 |
| 2 | 63.20 | 2572 |
| 3 | 63.04 | 3604 |
| 4 | 63.70 | 3724 |
| 5 | 60.51 | 2996 |

Coatings were applied to an uncoated 153.5 gsm free sheet (Bone Dry) at 3800 fpm on a cylindrical laboratory coater (CLC). The base paper had the following characteristics: basis weight: 153.5 gsm (Bone Dry) and 165.0 gsm (Air Dry-7% moisture); smoothness: 5.98 microns±0.19; brightness: 90.07%±0.15.

The CLC was set-up using a 0.020 inch coating blade, 0.025 inch backing blade and 0.375 inch extension. A coat weight of 10 gsm was targeted. After coating, samples were cut to test size and conditioned to TAPPI Standards. After conditioning, the optical properties (gloss, brightness and L*, a*, b* color) and smoothness were measured according to TAPPI standard test methods. Smoothness was measured using a Parker Print Surface tester. The samples were then calendered through 2 nips against the steel roll at 150° F. and 160° F. and 600 and 1200 pli. Temperatures were not increased above 160° F. to prevent blocking problems (sticking to the metal roll).

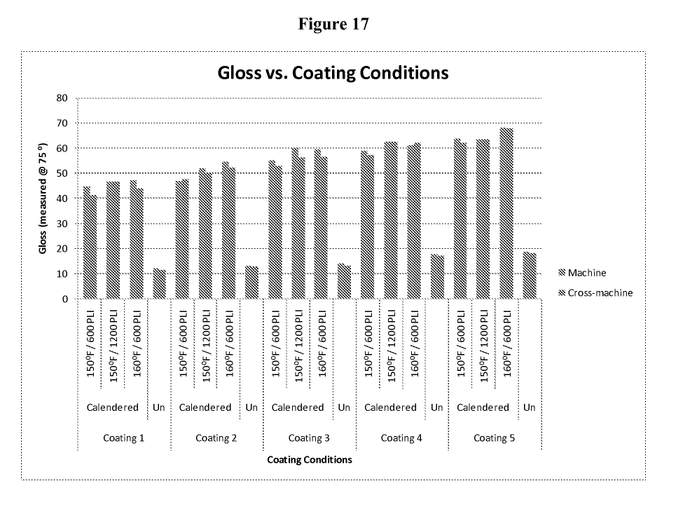

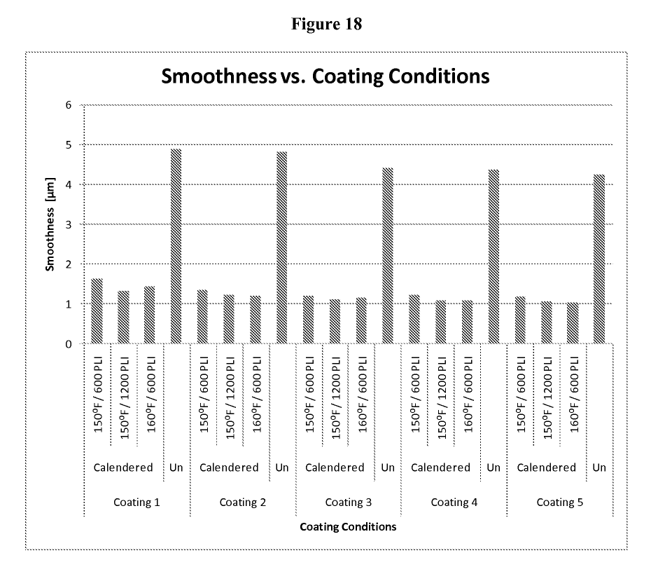

The results in FIG. 17 show an increase in gloss with a 5 part replacement of GCC with aluminum phosphate pigment. A higher increase in gloss was observed with the 5 part replacement of GCC with plastic pigment. A comparison of coating 3 to coating 4 indicates that 10 parts aluminum phosphate pigment coating had a comparable gloss to the 5 part plastic pigment coating. It should be noted that the 10 part plastic pigment coating was prepared on an actual dry pigment solids basis of 25%. Plastic pigment is sold on an effective solids basis of 50%. Hence, on an effective solids basis one should compare coatings 3 and 4. This comparison shows the gloss of the aluminum phosphate pigment coating to be comparable to the plastic pigment coating. The slight differences are attributed to differences in the calendering response of the two pigments. The plastic pigment responded better to calendering temperature than aluminum phosphate pigment. The smoothness values of the coatings correspond well to the gloss results (FIG. 18 and Tables 3-4).

TABLE 3
Gloss Values at 75° (%)
Gloss

| | Calendered | | | | | | | |
|---|---|---|---|---|---|---|---|---|
| | 150° F./600 PLI | | 150° F./1200 PLI | | 160° F./600 PLI | | Uncalendered | |
| Coating # | Average | STDEV | Average | STDEV | Average | STDEV | Average | STDEV |

Machine direction

| | | | | | | | | |
|---|---|---|---|---|---|---|---|---|
| 1 | 44.65 | 2.45 | 46.65 | 3.16 | 47.26 | 3.04 | 12.16 | 0.57 |
| 2 | 47.02 | 4.69 | 51.85 | 4.59 | 54.45 | 4.66 | 13.27 | 0.45 |
| 3 | 55.22 | 3.26 | 59.96 | 3.39 | 59.49 | 3.90 | 14.05 | 0.83 |
| 4 | 58.97 | 4.82 | 62.37 | 2.64 | 61.16 | 4.85 | 17.86 | 1.43 |
| 5 | 63.90 | 4.38 | 63.58 | 3.66 | 67.96 | 4.41 | 18.75 | 2.08 |

Cross-machine direction

| | | | | | | | | |
|---|---|---|---|---|---|---|---|---|
| 1 | 41.46 | 2.55 | 46.72 | 1.31 | 43.89 | 1.53 | 11.69 | 0.58 |
| 2 | 47.61 | 1.02 | 50.32 | 1.55 | 52.19 | 1.49 | 12.80 | 0.58 |
| 3 | 52.91 | 2.18 | 56.34 | 1.81 | 56.60 | 2.19 | 13.12 | 0.81 |
| 4 | 57.09 | 1.76 | 62.37 | 1.34 | 61.99 | 2.07 | 17.03 | 0.50 |
| 5 | 62.08 | 1.83 | 63.45 | 2.78 | 67.87 | 1.85 | 18.32 | 0.93 |

TABLE 4
Parker Print Smoothness Values (microns)
Smoothness

| | Calendered | | | | | | | |
|---|---|---|---|---|---|---|---|---|
| | 150° F./600 PLI | | 150° F./1200 PLI | | 160° F./600 PLI | | Uncalendered | |
| Coating # | Average | STDEV | Average | STDEV | Average | STDEV | Average | STDEV |
| 1 | 1.625 | 0.211 | 1.338 | 0.032 | 1.445 | 0.134 | 4.886 | 0.157 |
| 2 | 1.342 | 0.066 | 1.225 | 0.037 | 1.214 | 0.075 | 4.818 | 0.159 |
| 3 | 1.213 | 0.068 | 1.103 | 0.035 | 1.166 | 0.086 | 4.409 | 0.362 |
| 4 | 1.234 | 0.075 | 1.088 | 0.045 | 1.095 | 0.106 | 4.359 | 0.310 |
| 5 | 1.182 | 0.043 | 1.065 | 0.061 | 1.054 | 0.088 | 4.234 | 0.223 |

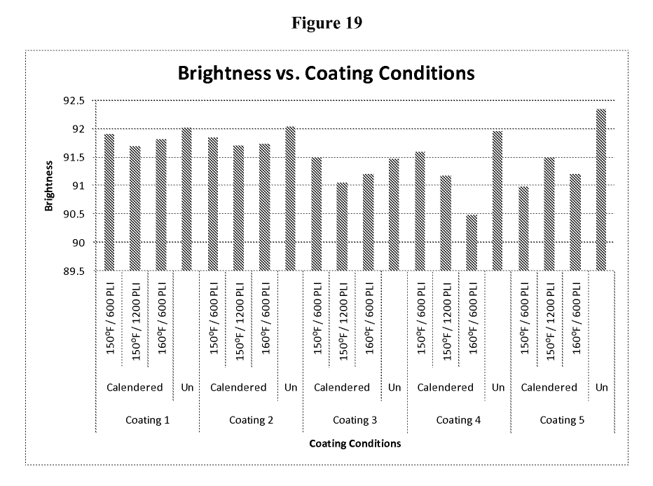

The brightness values of the coatings containing aluminum phosphate pigment are also comparable to the coatings containing plastic pigment (FIG. 19 and Table 5).

TABLE 5
Brightness Values
Brightness [%]

| | Calendered | | | | | | | |
|---|---|---|---|---|---|---|---|---|
| | 150° F./600 PLI | | 150° F./1200 PLI | | 160° F./600 PLI | | Uncalendered | |
| Coating # | Average | STDEV | Average | STDEV | Average | STDEV | Average | STDEV |
| 1 | 91.90 | 0.15 | 91.69 | 0.16 | 91.82 | 0.08 | 92.01 | 0.09 |
| 2 | 91.85 | 0.30 | 91.71 | 0.04 | 91.74 | 0.08 | 92.03 | 0.08 |
| 3 | 91.48 | 0.16 | 91.04 | 0.13 | 91.21 | 0.17 | 91.47 | 0.14 |
| 4 | 91.60 | 0.11 | 91.17 | 0.18 | 90.48 | 2.11 | 91.95 | 0.07 |
| 5 | 90.98 | 1.52 | 91.48 | 0.23 | 91.21 | 0.09 | 92.35 | 0.13 |

Review of Table 6, shows no significant difference between L*, a*, b* color values.

TABLE 6
CIE L*, a*, b* Color Values
CIE LAB

| | Calendered | | | | | | | | | | | |
|---|---|---|---|---|---|---|---|---|---|---|---|---|
| | 150° F./600 PLI | | | 150° F./1200 PLI | | | 160° F./600 PLI | | | Uncalendered | | |
| Coating # | L* | a* | b* | L* | a* | b* | L* | a* | b* | L* | a* | b* |
| 1 | 95.85 | 1.23 | −1.46 | 95.74 | 1.25 | −1.50 | 95.83 | 1.20 | −1.41 | 95.99 | 1.14 | −1.25 |
| 2 | 95.85 | 1.22 | −1.42 | 95.73 | 1.27 | −1.56 | 95.83 | 1.22 | −1.37 | 96.06 | 1.11 | −1.14 |
| 3 | 95.92 | 1.07 | −0.98 | 95.75 | 1.09 | −1.70 | 95.85 | 1.03 | −0.94 | 96.11 | 0.91 | −0.64 |
| 4 | 95.84 | 1.09 | −1.21 | 95.69 | 1.10 | −1.19 | 95.40 | 1.14 | −1.16 | 96.22 | 0.91 | −0.74 |
| 5 | 95.79 | 1.24 | −1.36 | 95.60 | 1.15 | −1.60 | 95.70 | 1.01 | −1.17 | 96.25 | 0.96 | −1.02 |

As seen from the data, on an effective solids basis, aluminum phosphate pigment provided comparable gloss values to the plastic pigment formulations. The brightness and L*, a*, b*, of aluminum phosphate pigment was also comparable to the plastic pigment formulations. The rheologies of coatings containing aluminum phosphate pigment were comparable to coatings containing plastic pigment.

### Example 2

### Comparison of Aluminum Phosphate Pigment with TiO₂ Pigment

Coatings were prepared according to Table 7. The delaminated clay was dispersed at 68.0% solids under a high shear Cowles disperser. The No. 2 clay pigment was dispersed at 71.8% solids. Although aluminum phosphate pigment and TiO₂ slurries with solids of 34.2% solids and 62.4% respectively, were redispersed with the high shear Cowles disperser prior to use.

TABLE 7
Coating Formulations
Coating Formulations
pph of Ingredients Needed

| Ingredient | Form 1 | Form 2 | Form 3 | Form 4 |
|---|---|---|---|---|
| Delaminated Clay | 60 | 60 | 60 | 60 |
| No. 2 Clay | 33 | 33 | 33 | 33 |
| Titanium Dioxide | 7 | 5.25 | 3.5 | 0 |
| Pigment X | 0 | 1.75 | 3.5 | 7 |
| SBR Latex | 6 | 6 | 6 | 6 |
| Starch | 12 | 12 | 12 | 12 |
| Lubricant | 0.7 | 0.7 | 0.7 | 0.7 |
| Crosslinker | 0.5 | 0.5 | 0.5 | 0.5 |
| Dispersant (wet/drypigment) | 0.1 | 0.1 | 0.1 | 0.1 |
| Total | 119.30 | 119.3 | 119.3 | 119.3 |

After dispersing the pigments were the other coating components were added under mild agitation using a mixer in the order listed in Table 8.

TABLE 8
Coating Components

| Order of | Coating | | |
|---|---|---|---|
| addition | Component | Product Specification | Company Name |
| 1 | Delaminated Clay | NUClay | Engelhard |
| | | | Corporation |
| 2 | No. 2 Clay | Hydrasperse 90 | Huber |
| | | | Corporation |
| 3 | Titanium Dioxide | TiPure RS | Dupont |
| 4 | aluminum | | |
| | phosphate | | |
| | pigment | | |
| 5 | Dispersant | Dispex N-40 | CIBA |
| 6 | Lubricant | Nopcoat C-104 | Henkel |
| 7 | Starch | Penford Gum 280 | Penford Products |
| | | | Co. |
| 8 | SBR Latex | Latex CP 620 NABK | Dow Chemical |
| 9 | Crosslinker | SEQUAREZ 755 | Omnova |

A 26% solid solution of starch was prepared by adding dry Penford Gum 280 to a stainless steal beaker of cool water under agitation. The beaker was placed on a steam table and the mixture heated to 190° F. for 30 minutes. After combining all the coating components, the solids contents of the coatings were measured. These values are reported in Table 9. The Brookfield viscosities of the coatings are also shown in Table 9.

TABLE 9
Low Shear Viscosity of Coatings

| | Contents solid | |
|---|---|---|
| Formulation # | [%] | Viscosity (cps) |
| 1 | 59.03 | 170 |
| 2 | 58.34 | 89 |
| 3 | 59.43 | 216 |
| 4 | 57.00 | 240 |

Coatings were applied to an uncoated 32.0 gsm wood containing paper (Bone Dry) at 1500 fpm on a cylindrical laboratory coater, CLC. The base paper had the following characteristics: basis weight: 31.8 gsm (Bone Dry) and 34.25 gsm (Air Dry-7.2% moisture); smoothness: 4.61 microns±0.27; Opacity: 72.56%±1.88.

The CLC was set-up using a 0.020 inch coating blade, 0.025 inch backing blade, and 0.625 inch extension. Coatings were applied at 6.0+0.5 gsm. After coating, the samples were cut and conditioned to TAPPI Standards. After conditioning, the optical properties (opacity, gloss, brightness and L, a, b) and smoothness were measured according to TAPPI standard test methods. Smoothness was measured using a Parker Print Surface tester. The samples were then calendered through 2 nips against the steel roll at 155° F. and 1200 pli.

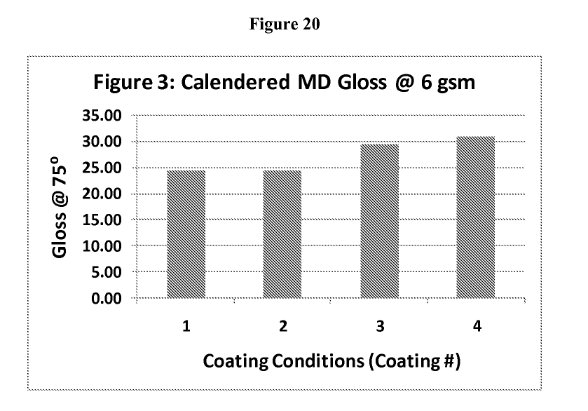

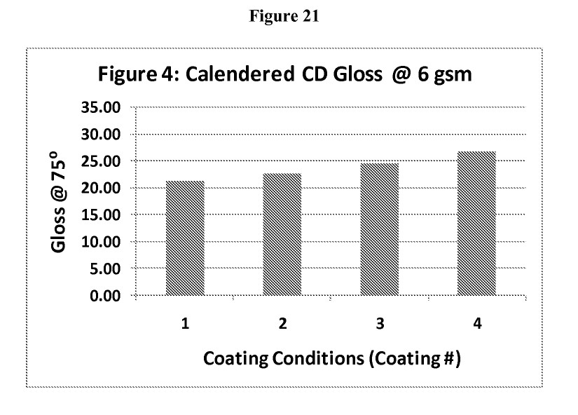

FIGS. 20 and 21 and Table 10 show the gloss to improve with the addition of aluminum phosphate pigment. A significant improvement in gloss was obtained by fully replacing the TiO₂ with aluminum phosphate pigment.

TABLE 10
Gloss Values (%)
Gloss

| | | | |
|---|---|---|---|
| Coating | Coat Weight | | |
| Formulation # | (gsm) | Uncalendered | Calendered |

Machine direction

| | | | |
|---|---|---|---|
| 1 | 6.0 | 8.35 | 24.30 |
| 2 | 6.0 | 8.01 | 24.30 |
| 3 | 6.0 | 8.67 | 29.32 |
| 4 | 6.0 | 8.38 | 30.74 |

Cross-machine direction

| | | | |
|---|---|---|---|
| 1 | 6.0 | 8.37 | 21.14 |
| 2 | 6.0 | 9.27 | 22.58 |
| 3 | 6.0 | 8.69 | 24.46 |
| 4 | 6.0 | 8.96 | 26.62 |

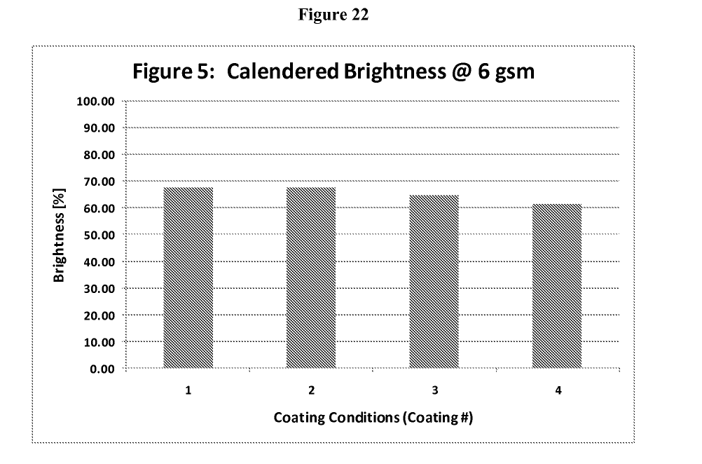

The brightness of the coating decreased with the addition of aluminum phosphate pigment as seen in FIG. 22 and Table 11.

TABLE 11
Influence of Calendering on Brightness (%)
Brightness

| Coating | Coat Weight | | |
|---|---|---|---|
| Formulation # | (gsm) | Uncalendered | Calendered |
| 1 | 6.00 | 70.16 | 67.79 |
| 2 | 6.00 | 71.05 | 67.79 |
| 3 | 6.00 | 67.04 | 64.57 |
| 4 | 6.00 | 63.64 | 61.27 |

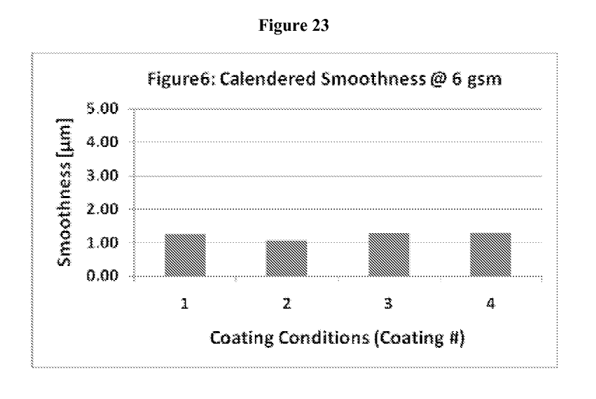

As seen from FIG. 23 and Table 12, the smoothness did not have much impact.

TABLE 12
Parker Print Smoothness Values
Smoothness [μm]

| | Coat | | |
|---|---|---|---|
| Coating | Weight | | |
| Formulation # | (gsm) | Uncalendered | Calendered |
| 1 | 6.00 | 4.40 | 1.25 |
| 2 | 6.00 | 4.36 | 1.08 |
| 3 | 6.00 | 4.81 | 1.28 |
| 4 | 6.00 | 4.47 | 1.29 |

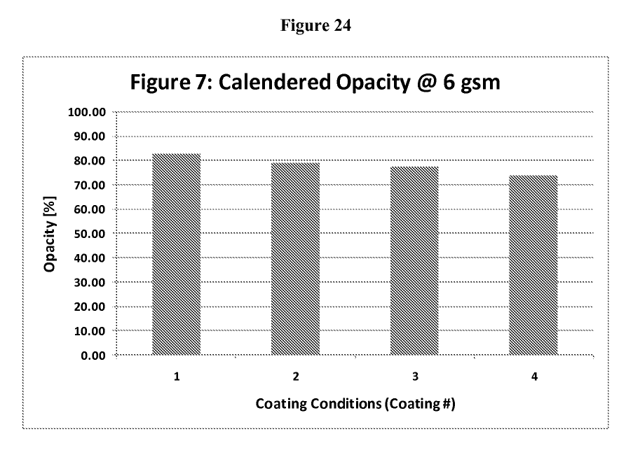

The replacement of TiO₂ with aluminum phosphate pigment did not significantly lower the opacity of the coatings as seen from FIG. 24 and Table 13.

TABLE 13
Influence of Calendering on Opacity (%)
Opacity

| Coating | Coat Weight | | |
|---|---|---|---|
| Formulation # | (gsm) | Uncalendered | Calendered |
| 1 | 6.00 | 81.66 | 82.66 |
| 2 | 6.00 | 81.61 | 79.01 |
| 3 | 6.00 | 81.79 | 77.42 |
| 4 | 6.00 | 76.87 | 73.77 |

The results indicate that aluminum phosphate pigment is a suitable 1:1 replacement for TiO₂ as an opacifying agent and a better glossing pigment. The additional increase in gloss may result in less calendering pressure being needed to obtain a desired level of gloss.

The ability to obtain equal gloss at lower calendering pressure would result in higher opacity, brightness and greater stiffness. All of which are of considerable benefit to the papermaker.

The L* values followed the brightness values, as both decreased with addition of aluminum phosphate pigment. The a* and b* values were not significantly affected.

TABLE 14
CIE L*, a*, b* Color Values
CIE LAB

| Coating | Coat Weight | Uncalendered | | | Calendered | | |
|---|---|---|---|---|---|---|---|
| Formulation # | (gsm) | L* | a* | b* | L* | a* | b* |
| 1 | 3.87 | 90.02 | 0.22 | 8.05 | 89.40 | 0.15 | 8.53 |
| | 5.14 | 90.82 | 0.10 | 6.75 | 89.98 | 0.08 | 7.82 |
| | 5.49 | 90.66 | 0.17 | 7.03 | 89.95 | 0.13 | 7.80 |
| 2 | 4.10 | 89.96 | 0.09 | 8.01 | 89.57 | 0.12 | 8.43 |
| | 4.53 | 90.57 | 0.16 | 7.14 | 89.51 | 0.10 | 8.31 |
| | 4.93 | 90.80 | 0.14 | 7.14 | 89.91 | 0.08 | 7.94 |
| 3 | 7.08 | 90.38 | 0.40 | 7.62 | 90.00 | 0.38 | 7.90 |
| | 5.74 | 89.86 | 0.45 | 8.43 | 89.17 | 0.45 | 9.04 |
| 4 | 7.33 | 89.24 | 0.64 | 9.71 | 88.44 | 0.55 | 10.63 |
| | 4.60 | 89.07 | 0.46 | 9.78 | 88.36 | 0.49 | 10.57 |

The data indicate that aluminum phosphate pigment is a suitable 1:1 replacement for TiO₂ as an opacifying agent and is a better glossing pigment. The additional increase in gloss can result in less calendering pressure being needed to obtain a desired level of gloss. The ability to obtain equal gloss at lower calendering pressure would enable the preservation of more opacity, brightness and stiffness. All of which are desired to be retained by the papermaker.

### Example 3

### Optical Brightener Study on a Coated Free Sheet

Coatings were prepared according to the formulations given in Table 15 and order of addition given in Table 16.

TABLE 15
Coating Formulation
pph of Ingredient Needed

| | Form 1 | Form 2 | Form 3 |
|---|---|---|---|
| Ingredient | (0 PX) | (5 PX) | (10 PX) |
| GCC | 60 | 60 | 60 |
| No. 1 Premium coating clay | 40 | 35 | 30 |
| Aluminum phsphate Pigment | 0 | 5 | 10 |
| SBR latex | 14 | 14 | 14 |
| CMC | 0.7 | 0.7 | 0.7 |
| PVOH | 0/1 | 0/1 | 0/1 |

TABLE 16
Order of addition
Order of addition

| # | Ingredient |
|---|---|
| 1 | GCC |
| 2 | CMC |
| 3 | No. 1 Premium Coating Clay |
| 4 | Pigment X |
| 5 | SBR |
| 6 | PVOH |
| 7 | OBA ½ |

The GCC, HydroCarb 90, was dispersed at solids 72% using a high shear Cowles disperser for 20 minutes. After 20 minutes of dispersing, dry FinnFix CMC, was added to the GCC and the mixture allowed to disperse an additional 5 minutes. While the CMC was thickening, the pH of a 70% solids No. 1 coating clay, Hydrafine, was adjusted to a pH=8 using Ammonium Hydroxide. This was done to prevent pigment shock when adding to the GCC. The clay was then added to the GCC. After dispersing for 5 minutes, the thickened pigment slip was then moved to a mixer where the SB latex was added.

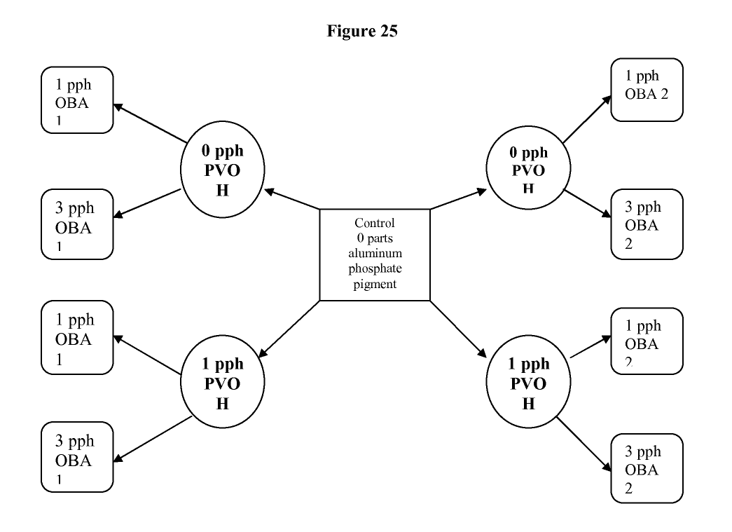

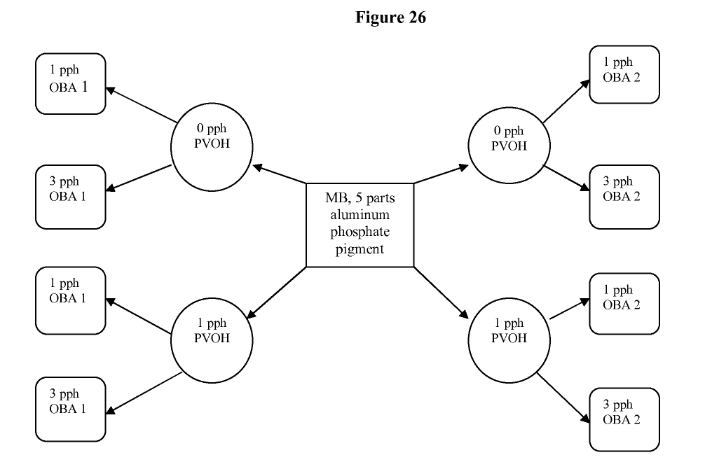

As shown in Table 15, Formulation #1 was prepared without aluminum phosphate pigment. In the next two formulations, 5 and 10 parts of the No. 1 clay was substituted with aluminum phosphate pigment. Master batches were prepared in accordance with FIGS. 25, 26 & 27. Master batches, MB, of coating formulations 1, 2 & 3 were prepared to ensure all 8 coatings prepared with and without OBA, and PVOH, were at similar solids. The PVOH and OBA (Leucophor T100 HQ and Luecophor BCW liquid, tetrasulfo and hexasulfo, respectively) were added to a pre-weighed amount of coating taken from the MB. The OBA was added last. The PVOH was added at 30% solids. The PVOH used was Celvol 203. After mixing, the solids of the coatings were measured. These values are reported in Table 17.

TABLE 17
Solids contents
Solids Contents

| Formulation # | Content of solids [%] |
|---|---|
| 1 (0 PX) | 61.83 ± 0.61% |
| 2 (5 PX) | 62.59 ± 0.34% |
| 3 (10 PX) | 63.28 ± 0.55% |

A total of 24 coatings were applied and tested.

The coatings were applied to an uncoated, 61.5 gsm, OBA free sheet with a cylindrical laboratory coater, CLC, at 3000 fpm. A coat weight of 10±0.5 gsm was targeted. The base paper characteristics are summarized in Table 18.

TABLE 18
Base paper characteristics
Base paper characteristics

| Substrate | Free sheet |
|---|---|
| Weight [gsm] | 61.5 |
| Smoothness [μm] | 5.21 |
| Brightness [%] | 88.05 |
| UV | 0.74 |
| L* | 94.94 |
| a* | 0.17 |
| b* | −0.13 |

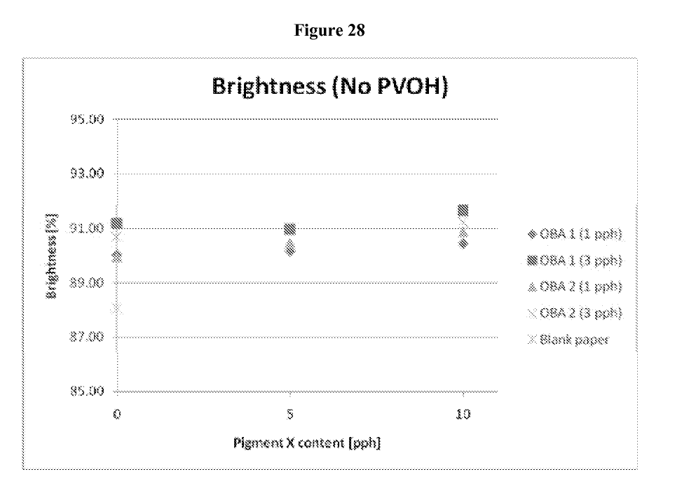

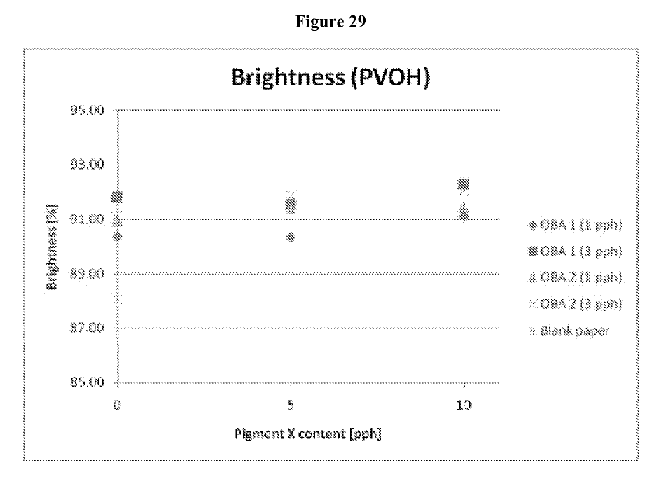

FIGS. 28 and 29 and Table 19 show a slight increase in brightness with the addition of Pigment X, for both OBAs used. The addition of 1 part PVOH improved the brightness slightly. The Hexasulfo OBA improved the brightness more than the Tetrasulfo OBA.

TABLE 19
Brightness with and without the addition of PVOH
Brightness [%]

| PX | OBA# | PVOH | OBA (pph) | Average [%] | STDEV |
|---|---|---|---|---|---|
| 0 | 1 | No PVOH | 1 | 90.05 | 0.10 |
| | | | 3 | 91.20 | 0.16 |
| | | PVOH | 1 | 90.37 | 0.10 |
| | | | 3 | 91.82 | 0.12 |
| | 2 | No PVOH | 1 | 89.95 | 0.16 |
| | | | 3 | 90.72 | 0.13 |
| | | PVOH | 1 | 90.96 | 0.20 |
| | | | 3 | 91.09 | 0.08 |
| 5 | 1 | No PVOH | 1 | 90.17 | 0.12 |
| | | | 3 | 90.96 | 0.13 |
| | | PVOH | 1 | 90.33 | 0.15 |
| | | | 3 | 91.56 | 0.16 |
| | 2 | No PVOH | 1 | 90.47 | 0.17 |
| | | | 3 | 90.99 | 0.12 |
| | | PVOH | 1 | 91.39 | 0.12 |
| | | | 3 | 91.90 | 0.13 |
| 10 | 1 | No PVOH | 1 | 90.44 | 0.12 |
| | | | 3 | 91.65 | 0.14 |
| | | PVOH | 1 | 91.10 | 0.13 |
| | | | 3 | 92.28 | 0.17 |
| | 2 | No PVOH | 1 | 90.89 | 0.12 |
| | | | 3 | 91.22 | 0.19 |
| | | PVOH | 1 | 91.45 | 0.08 |
| | | | 3 | 92.05 | 0.12 |

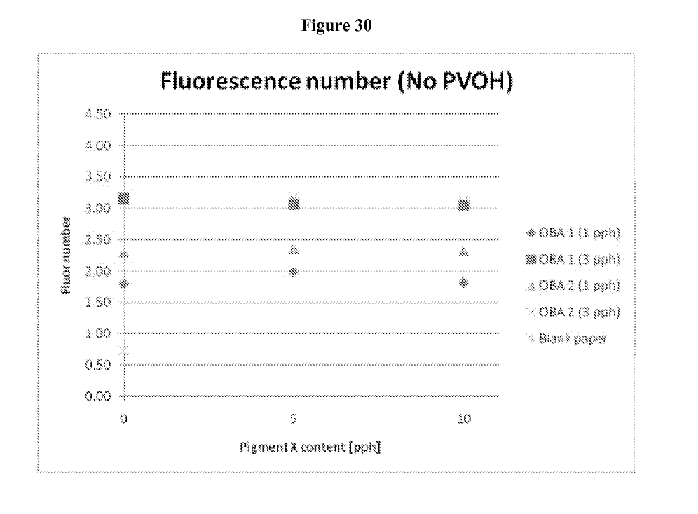

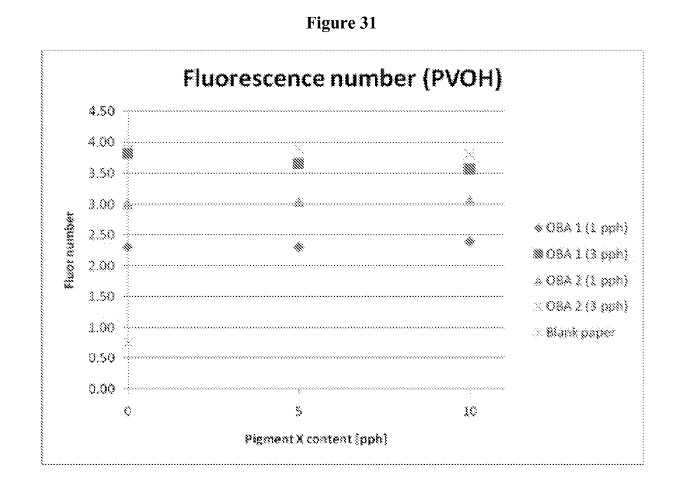

The change in fluorescence number is reported for each coating in FIGS. 30 and 31 and Table 20. The increase in fluorescence number indicates the improvement in brightness due to the OBA.

TABLE 20
Fluorescence number with and without the addition of PVOH
Fluorescence number

| PX | OBA# | PVOH | OBA (pph) | Average | STDEV |
|---|---|---|---|---|---|
| 0 | 1 | No PVOH | 1 | 1.80 | 0.02 |
| | | | 3 | 3.15 | 0.05 |
| | | PVOH | 1 | 2.31 | 0.03 |
| | | | 3 | 3.82 | 0.12 |
| | 2 | No PVOH | 1 | 2.29 | 0.03 |
| | | | 3 | 3.16 | 0.05 |
| | | PVOH | 1 | 3.01 | 0.15 |
| | | | 3 | 3.86 | 0.06 |
| 5 | 1 | No PVOH | 1 | 1.99 | 0.02 |
| | | | 3 | 3.06 | 0.03 |
| | | PVOH | 1 | 2.30 | 0.04 |
| | | | 3 | 3.65 | 0.08 |
| | 2 | No PVOH | 1 | 2.36 | 0.06 |
| | | | 3 | 3.15 | 0.03 |
| | | PVOH | 1 | 3.04 | 0.09 |
| | | | 3 | 3.89 | 0.13 |
| 10 | 1 | No PVOH | 1 | 1.82 | 0.04 |
| | | | 3 | 3.05 | 0.07 |
| | | PVOH | 1 | 2.39 | 0.11 |
| | | | 3 | 3.56 | 0.12 |
| | 2 | No PVOH | 1 | 2.33 | 0.11 |
| | | | 3 | 3.09 | 0.03 |
| | | PVOH | 1 | 3.07 | 0.15 |
| | | | 3 | 3.81 | 0.05 |

A comparison of FIGS. 6 and 7 shows an improvement in fluorescence number with the addition of PVOH and no significant decrease in fluorescence number with the addition of Pigment X. So unlike TiO₂, Pigment X does not interfere with the OBA. This is because, unlike TiO₂, Pigment X does not absorb UV light. The opacifying properties of Pigment X are believed to result from the inclusion of air in the micro voids of its structure. These small air pockets diffract light, increasing the opacity of the coating layer.

A brightness comparison of the control coatings with PVOH and Pigment X substituted coatings without PVOH reveals that equal brightness can be obtained. This finding indicates a beneficial cost saving to the coating formulator.

Table 21 provides data for L*a*b* color values with and without the addition of PVOH.

TABLE 21
L* a* b* color values with and without the addition of PVOH
CIE LAB

| PX | OBA# | PVOH | OBA (pph) | L* | STDEV | a* | STDEV | b* | STDEV |
|---|---|---|---|---|---|---|---|---|---|
| 0 | 1 | No PVOH | 1 | 95.84 | 0.09 | 0.33 | 0.05 | −0.04 | 0.10 |
| | | | 3 | 95.90 | 0.10 | 0.64 | 0.06 | −0.89 | 0.08 |
| | | PVOH | 1 | 95.81 | 0.07 | 0.55 | 0.06 | −0.41 | 0.07 |
| | | | 3 | 96.34 | 0.23 | 0.84 | 0.05 | −0.80 | 0.04 |
| | 2 | No PVOH | 1 | 95.76 | 0.09 | 0.46 | 0.07 | −0.15 | 0.09 |
| | | | 3 | 96.29 | 0.05 | 0.30 | 0.07 | 0.21 | 0.04 |
| | | PVOH | 1 | 96.25 | 0.05 | 0.59 | 0.04 | −0.14 | 0.08 |
| | | | 3 | 95.83 | 0.03 | 0.68 | 0.05 | −0.94 | 0.04 |
| 5 | 1 | No PVOH | 1 | 95.83 | 0.08 | 0.40 | 0.05 | −0.23 | 0.09 |
| | | | 3 | 95.89 | 0.07 | 0.63 | 0.08 | −0.77 | 0.10 |
| | | PVOH | 1 | 95.92 | 0.12 | 0.48 | 0.08 | −0.21 | 0.11 |
| | | | 3 | 95.84 | 0.07 | 0.93 | 0.08 | −1.38 | 0.09 |
| | 2 | No PVOH | 1 | 95.92 | 0.08 | 0.41 | 0.07 | −0.27 | 0.09 |
| | | | 3 | 95.94 | 0.06 | 0.43 | 0.08 | −0.60 | 0.10 |
| | | PVOH | 1 | 95.93 | 0.05 | 0.76 | 0.08 | −1.00 | 0.08 |
| | | | 3 | 95.96 | 0.09 | 0.73 | 0.08 | −1.30 | 0.10 |
| 10 | 1 | No PVOH | 1 | 95.92 | 0.04 | 0.41 | 0.04 | −0.20 | 0.07 |
| | | | 3 | 95.95 | 0.08 | 0.74 | 0.09 | −1.14 | 0.09 |
| | | PVOH | 1 | 95.97 | 0.07 | 0.60 | 0.07 | −0.67 | 0.08 |
| | | | 3 | 96.00 | 0.11 | 0.89 | 0.06 | −1.56 | 0.10 |
| | 2 | No PVOH | 1 | 95.86 | 0.06 | 0.52 | 0.02 | −0.65 | 0.06 |
| | | | 3 | 95.96 | 0.09 | 0.45 | 0.08 | −0.72 | 0.13 |
| | | PVOH | 1 | 95.90 | 0.04 | 0.73 | 0.07 | −1.08 | 0.08 |
| | | | 3 | 95.96 | 0.06 | 0.79 | 0.06 | −1.41 | 0.06 |

As seen from the data, at the lower level of OBA addition, the Hexaslufo OBA worked better. The addition of PVOH improved the brightness of the coatings. Aluminum phosphate pigment did not interfere with the OBA and it may eliminate the need for PVOH.

While the subject matter has been described with respect to a limited number of embodiments, the specific features of one embodiment should not be attributed to other embodiments of the invention. No single embodiment is representative of all aspects of the invention. In some embodiments, the compositions or methods may include numerous compounds or steps not mentioned herein. In other embodiments, the compositions or methods do not include, or are substantially free of, any compounds or steps not enumerated herein. Variations and modifications from the described embodiments exist. Finally, any number disclosed herein should be construed to mean approximate, regardless of whether the word “about” or “approximately” is used in describing the number. The appended claims intend to cover all those modifications and variations as falling within the scope of the invention.

What is claimed is:

1. A coated paper comprising a coating composition on at least one side of a base paper, wherein the coating composition comprises an amorphous aluminum phosphate or polyphosphate pigment.

2. The coated paper as recited in claim 1 comprising from about 5 g/m² to about 30 g/m² of the coating composition.

3. The coated paper as recited in claim 1, wherein the coating composition further comprises an additive.

4. The coated paper as recited in claim 2, wherein the additive is selected from the group consisting of binders, lubricants, dispersants, eveners, defoamers, wetting agents, optical brighteners, biocides, cross-linkers, water retention aids, viscosity modifiers, and thickeners and combinations thereof.

5. The coated paper as recited in claim 1, wherein the pigment is present in an amount greater than about 1%, 3%, 5%, 10%, 12%, 15%, 20%, 30% or 50% based on total weight of solids in the composition.

6. The coated paper as recited in claim 1, wherein the pigment has a skeletal density of between 1.95 and 2.50 grams per cubic centimeter and a phosphorus to aluminum mole ratio of 1.

7. The coated paper as recited in claim 1, wherein the pigment comprises 1 to 4 closed voids per particle.

8. The coated paper as recited in claim 1, wherein the pigment is characterized by particle size distribution between about 0.1 to about 5 microns.

9. The coated paper as recited in claim 8, wherein the pigment is characterized by a particle size distribution between about 0.2 to about 0.6 microns.

10. The coated paper as recited in claim 8, wherein the pigment is characterized by a particle size distribution between about 0.6 to about 1.5 microns.

11. The coated paper as recited in claim 8, wherein the pigment is characterized by a particle size distribution between about 1.0 to about 3.0 microns.

12. The coated paper as recited in claim 1, wherein the pigment is characterized by an average individual particle radius size of between about 10 and 80 nanometers, when in dry powder form.

13. The coated paper as recited in claim 4, wherein the binder is selected from the group consisting of a protein, starch, gum, resin, emulsion polymer or a combination thereof.

14. The coated paper as recited in claim 1, wherein the coating composition further comprises one or more additional pigment selected from the group consisting of calcium carbonate, calcined kaolin, hydrous kaolin, China clay, talc, mica, dolomite, silica, silicates, zeolite, gypsum, satin white, titania, titanium dioxide, calcium sulfate, barium sulfate, aluminum trihydrate, plastic pigment, and combinations thereof.

15. The coated paper as recited in claim 14, wherein the additional pigment is TiO₂.

16. The coated paper as recited in claim 15, wherein the coating composition comprises the amorphous aluminum phosphate or polyphosphate pigment in an amount from about 1% to about 40%, and the TiO₂ pigment in an amount from about 1% to about 40% based on total weight of solids in the composition.

17. The coated paper as recited in claim 15, wherein the coating composition comprises the amorphous aluminum phosphate or polyphosphate pigment and the TiO₂ pigment in a ratio of about 1:1.

18. The coated paper as recited in claim 15, wherein the coating composition comprises the amorphous aluminum phosphate or polyphosphate pigment and the TiO₂ pigment in a ratio of about 1:2.

19. The coated paper as recited in claim 1, wherein the coated paper is selected from the group consisting of a coated color copying paper, coated xerography paper, coated screen printing paper, coated gravure paper, coated dye-sublimation paper, coated flexography paper, coated inkjet printing paper, coated photography paper, coated rotary offset printing paper, coated electrophotographic printing paper, coated image recording paper for the thermal transfer recording, coated ink jet recording paper, and combinations thereof.

20. The coated paper as recited in claim 1, wherein the coated paper is a coated ink jet paper or coated digital printing paper.

21. The coated paper as recited in claim 1, wherein the coated paper is a coated publishing paper.

22. The coated paper as recited in claim 1 having a coating gloss equal to or greater than about 20% at 75° measured by TAPPI test method T480 om-92.

23. The coated paper as recited in claim 1 having a coating gloss from about 25% to about 75% at 75°.

24. The coated paper as recited in claim 1 having a smoothness of less than 5.0 as measured using TAPPI test method for Parker Print Surface: T555 om-99.

25. The coated paper as recited in claim 1 having a smoothness from about 1.0 to about 2.5 as measured using TAPPI test method for Parker Print Surface: T555 om-99.

26. The coated paper as recited in claim 1 having an opacity of greater than 80% as measured using TAPPI test method T425 om-91.

27. The coated paper as recited in claim 1 having the opacity from about 85% to about 99% as measured using TAPPI test method T425 om-91.

28. The coated paper as recited in claim 1 having a brightness greater than about 70% GE brightness as measured using TAPPI test method T452 om 92.

29. The coated paper as recited in claim 1 having a brightness from about 70% brightness to about 95% GE brightness as measured using TAPPI test method T452 om 92.

30. A process for preparing a coated paper comprising applying a coating composition to at least one side of a base paper, wherein the coating composition comprises an amorphous aluminum phosphate or polyphosphate pigment.

31. The process as recited in claim 30 wherein the amorphous aluminum phosphate or polyphosphate pigment is prepared by combining starting materials comprising phosphoric acid, aluminum sulfate, and sodium hydroxide.

32. The process as recited in claim 31 wherein the starting materials are combined simultaneously.

33. The process as recited in claim 31 wherein the starting materials react to form an amorphous aluminum phosphate or polyphosphate precipitate, wherein the precipitate is dried at a temperature of less than about 130° C., and wherein amorphous aluminum phosphate or polyphosphate particles formed during drying have one or more closed voids per particle.

34. The process as recited in claim 33 wherein the particles are substantially free of open pores.

35. The process as recited in claim 31 wherein the starting materials are combined together for about 30 minutes to form an amorphous aluminum phosphate or polyphosphate precipitate.

36. The process as recited in claim 30 wherein the amorphous aluminum phosphate or polyphosphate pigment is prepared by combining starting materials comprising phosphoric acid, aluminum hydroxide, and sodium aluminate.

37. The process as recited in claim 36 wherein the phosphoric acid and aluminum hydroxide are combined in a first step to produce an acidic aluminum phosphate solution or suspension, and the sodium aluminate is added to the solution or suspension in a second step.

38. The process as recited in claim 36 wherein the phosphoric acid, aluminum hydroxide, and sodium aluminate are combined in a single step.

39. The process as recited in claim 36 wherein the starting materials react to form an amorphous aluminum phosphate or polyphosphate precipitate, wherein the precipitate is dried at a temperature of less than about 130° C., and wherein amorphous aluminum phosphate or polyphosphate particles formed during drying have one or more closed voids per particle.

40. The process as recited in claim 39 wherein the particles are substantially free of open pores.

41. The process as recited in claim 31 further comprising calendering the coated paper to form a coating thereon.

42. The process as recited in claim 31, wherein the composition further comprises water.

43. The process as recited in claim 31, wherein the composition further comprises an additive.

44. The process as recited in claim 31, wherein the composition further comprises one or more additional pigment selected from the group consisting of calcium carbonate, calcined kaolin, hydrous kaolin, China clay, talc, mica, dolomite, silica, silicates, zeolite, gypsum, satin white, titania, titanium dioxide, calcium sulfate, barium sulfate, aluminum trihydrate, plastic pigment and combinations thereof.

45. The process as recited in claim 31, wherein the composition is applied to the base paper in an amount of from about 5 g/m² to about 30 g/m².

46. A high bulk coated paper comprising a base paper of a weight of 18 to 34 pounds per ream and a coating composition on at least one side of the base paper, wherein the composition comprises an amorphous aluminum phosphate or polyphosphate pigment, and the coating composition is of a weight of no more than 3 pounds per ream per side, and the base paper has a caliper of at least about 88% of the total caliper of the coated paper and the coating composition provides substantially the remainder of the caliper of the coated paper, so that the coated paper has a bulk factor of at least 55.

47. The coated paper as recited in claim 46 wherein the amorphous aluminum phosphate or polyphosphate pigment is prepared by combining starting materials comprising phosphoric acid, aluminum sulfate, and sodium hydroxide.

48. The coated paper as recited in claim 46 wherein the amorphous aluminum phosphate or polyphosphate pigment is prepared by combining starting materials comprising phosphoric acid, aluminum hydroxide, and sodium aluminate.

49. A lightweight high bulk coated paper comprising a base paper of a weight of about 26 to 36 pounds per ream, and a coating composition on at least one side of the base paper, wherein the composition comprises an amorphous aluminum phosphate or polyphosphate pigment, and the coating composition is of a weight of about 1.5 to 3.5 pounds per ream per side, and the base weight and the coating weight being selected so that the base has a caliper of at least about 75% of the total caliper of the coated paper and the coating composition provides substantially the remainder of the caliper of the coated paper, so that the coated paper has a bulk factor of at least 55.

50. The coated paper as recited in claim 49, wherein the amorphous aluminum phosphate or polyphosphate pigment is prepared by combining starting materials comprising phosphoric acid, aluminum sulfate, and sodium hydroxide.

51. The coated paper as recited in claim 49 wherein the amorphous aluminum phosphate or polyphosphate pigment is prepared by combining starting materials comprising phosphoric acid, aluminum hydroxide, and sodium aluminate.

52. An ultra lightweight high bulk coated paper comprising a base paper base of a weight on the order of about 18 to 24 pounds per ream, and a coating composition on at least one side of the base paper, wherein the composition comprises an amorphous aluminum phosphate or polyphosphate pigment, and the coating composition is of a weight of about 2 pounds per ream per side, and the base weight and the coating weight being selected so that the base has a caliper of at least about 75% of the total caliper of the coated paper and the coating composition provides substantially the remainder of the caliper of the coated paper, so that the coated paper has a bulk factor of at least 55.

53. The coated paper as recited in claim 52, wherein the amorphous aluminum phosphate or polyphosphate pigment is prepared by combining starting materials comprising phosphoric acid, aluminum sulfate, and sodium hydroxide.

54. The coated paper as recited in claim 52 wherein the amorphous aluminum phosphate or polyphosphate pigment is prepared by combining starting materials comprising phosphoric acid, aluminum hydroxide, and sodium aluminate.
